(19) United States
(12) Patent Application Publication
(10) Pub. No.: US 2025/0011604 A1
(43) Pub. Date: Jan. 9, 2025

(54) DAMAGE INDICATING COATING SYSTEM

(71) Applicant: PRC-Desoto International, Inc., Sylmar, CA (US)

(72) Inventors: Matthew Robert Davis, Burbank, CA (US); Gordon Lowry Post, Pittsburgh, PA (US); Tejveen Kaur Gill, Acton, CA (US); Stuart Damon Hellring, Pittsburgh, PA (US); Erinn M. Klass, McKinney, TX (US); Justin Jonathan Martin, Harrison City, PA (US); Michael Andrew Zalich, Wexford, PA (US)

(73) Assignee: PRC-Desoto International, Inc., Sylmar, CA (US)

(21) Appl. No.: 18/706,499

(22) PCT Filed: Nov. 1, 2022
(86) PCT No.: PCT/US2022/079022

§ 371 Date: May 1, 2024

Related U.S. Application Data
(60) Provisional application No. 63/275,030, filed on Nov. 3, 2021.

(51) Int. Cl. C09D 5/22; B05D 5/00; B05D 7/00; C08K 3/013; C08K 5/00; C09D 5/32; C09D 7/41; C09D 7/61; C09D 175/06; G01N 21/84; G01N 21/88

(52) U.S. Cl. CPC C09D 5/22; B05D 5/005; B05D 7/54; C08K 3/013; C08K 5/0041; C09D 5/32; C09D 7/41; C09D 7/61; C09D 175/06; G01N 21/8851; G01N 2021/8427

(57) ABSTRACT

A multi-layer coating system includes: a first coating layer formed from a first coating composition including: a film forming resin; and a fluorescent and/or phosphorescent pigment that: (1) emits radiation at an emission wavelength in the range of from 400-1200 nanometers when excited by ultraviolet and/or visible radiation corresponding to an excitation wavelength of the fluorescent and/or phosphorescent pigment; and/or (2) emits radiation at an emission wavelength in the range of from 600-2500 nanometers when excited by visible and/or near infrared radiation corresponding to an excitation wavelength of the fluorescent and/or phosphorescent pigment; and a second coating layer disposed over at least a portion of the first coating layer, which is formed from a second coating composition including: a film forming resin; and a pigment that blocks radiation corresponding to the excitation and/or emission wavelength of the fluorescent and/or phosphorescent pigment in the first coating layer.

### FIELD

The present disclosure relates to a multi-layer coating system, a method for detecting a damaged region of a coated substrate, a method of preparing a substrate coated by multi-layer coating system, and a kit for forming a multi-layer coating system.

### BACKGROUND

Scratches and gouges in a coated component can be an early indicator of the loss of structural integrity of a component. For example, in the design of vehicles, such as aircrafts, structural integrity of the components is important for the overall safe operation of the vehicle. Even slight damage to a component can result in loss of structural integrity. Thus, easy and early detection of potential areas of damage to these components is desirable.

### SUMMARY

The present disclosure is directed to a multi-layer coating system, including: a first coating layer formed from a first coating composition including: a film forming resin; and a fluorescent and/or phosphorescent pigment, where the fluorescent and/or phosphorescent pigment: (1) emits radiation at an emission wavelength in the range of from 400 to 1200 nanometers when excited by ultraviolet and/or visible radiation corresponding to an excitation wavelength of the fluorescent and/or phosphorescent pigment; and/or (2) emits radiation at an emission wavelength in the range of from 600 to 2500 nanometers when excited by visible and/or near infrared radiation corresponding to an excitation wavelength of the fluorescent and/or phosphorescent pigment; and a second coating layer disposed over at least a portion of the first coating layer, where the second coating layer is formed from a second coating composition including: a film forming resin; and a pigment that blocks radiation corresponding to the excitation and/or emission wavelength of the fluorescent and/or phosphorescent pigment in the first coating layer.

The present disclosure is also directed to a method for detecting a damaged region of a multi-layer coating system applied to a substrate, comprising detecting radiation emitted from a first coating layer formed from a first coating composition comprising: a film forming resin; and a fluorescent and/or phosphorescent pigment wherein the fluorescent and/or phosphorescent pigment: (1) emits radiation at an emission wavelength in the range of from 400 to 1200 nanometers when excited by ultraviolet and/or visible radiation corresponding to an excitation wavelength of the fluorescent and/or phosphorescent pigment; and/or (2) emits radiation at an emission wavelength in the range of from 600 to 2500 nanometers when excited by visible and/or near infrared radiation corresponding to an excitation wavelength of the fluorescent and/or phosphorescent pigment; and a second coating layer disposed over at least a portion of the first coating layer, where the second coating layer is formed from a second coating composition comprising: a film forming resin; and a pigment that blocks radiation corresponding to the excitation and/or emission wavelength of the fluorescent and/or phosphorescent pigment in the first coating layer; wherein the detection of radiation from the first coating layer indicates damage to at least the second coating layer.

The present disclosure is also directed to a method of preparing a substrate coated by a multi-layer coating system, including: applying a first coating composition to a substrate to form a first coating layer, the first coating composition including: a film forming resin; and a fluorescent and/or phosphorescent pigment, where the fluorescent and/or phosphorescent pigment: (1) emits radiation at an emission wavelength in the range of from 400 to 1200 nanometers when excited by ultraviolet and/or visible radiation corresponding to an excitation wavelength of the fluorescent and/or phosphorescent pigment; and/or (2) emits radiation at an emission wavelength in the range of from 600 to 2500 nanometers when excited by visible and/or near infrared radiation corresponding to an excitation wavelength of the fluorescent and/or phosphorescent pigment; and applying a second coating composition to form a second coating layer disposed over at least a portion of the first coating layer, the second coating composition including: a film forming resin; and a pigment that blocks radiation corresponding to the excitation and/or emission wavelength of the fluorescent and/or phosphorescent pigment in the first coating layer.

The present disclosure is also directed to a kit for forming a multi-layer coating system, including: a first container including a first coating composition including: a film forming resin; and a fluorescent and/or phosphorescent pigment, where the fluorescent and/or phosphorescent pigment: (1) emits radiation at an emission wavelength in the range of from 400 to 1200 nanometers when excited by ultraviolet and/or visible radiation corresponding to an excitation wavelength of the fluorescent and/or phosphorescent pigment; and/or (2) emits radiation at an emission wavelength in the range of from 600 to 2500 nanometers when excited by visible and/or near infrared radiation corresponding to an excitation wavelength of the fluorescent and/or phosphorescent pigment; and a second container including a second coating composition including: a film forming resin; and a pigment that blocks radiation corresponding to the excitation and/or emission wavelength of the fluorescent and/or phosphorescent pigment in the first coating layer.

### BRIEF DESCRIPTION OF THE DRAWINGS

FIG. 1 shows a partially schematic cross-sectional view of a multi-layer coating system according to the present disclosure;

FIG. 2 shows a partially schematic cross-sectional view of a multi-layer coating system according to the present disclosure;

FIG. 3 shows a partially schematic cross-sectional view of a multi-layer coating system according to the present disclosure;

FIG. 4 shows a partially schematic cross-sectional view of a multi-layer coating system according to the present disclosure;

FIG. 5 shows a partially schematic view of a system for detecting a damaged region of a multi-layer coating system according to the present disclosure;

FIG. 6 shows a partially schematic view of a system for detecting a damaged region of a multi-layer coating system according to the present disclosure;

FIG. 7 shows a schematic view of a detection system for detecting a damaged region of a coated substrate according to the present disclosure;

FIG. 8 shows a schematic view of a kit for forming a multi-layer coating system according to the present disclosure;

FIGS. 9A-9D show images of the damaged multi-layer coating system prepared according to Example 1;

FIGS. 10A-10D show images of the damaged multi-layer coating system prepared according to Example 2;

FIGS. 11A-11D show images of the damaged multi-layer coating system prepared according to Example 3;

FIGS. 12A-12D show images of the damaged multi-layer coating system prepared according to Example 4;

FIGS. 13A-13E show images of the damaged multi-layer coating system prepared according to Examples 5 and 6;

FIGS. 14A-14H show images of the damaged multi-layer coating system prepared according to Examples 7 and 8;

FIGS. 15A-15H show images of the damaged multi-layer coating system prepared according to Examples 9 and 10; and

FIGS. 16A and 16B show images of the damaged multi-layer coating system prepared according to Examples 11 and 12.

### DESCRIPTION OF THE DISCLOSURE

For the purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” film-forming resin, “a” fluorescent and/or phosphorescent pigment, “a” pigment that blocks radiation, and the like refer to one or more of any of these items.

As used herein, a “film forming resin” refers to a resin forming a self-supporting continuous film on at least a horizontal surface of a substrate upon removal of any diluents or carriers present in the composition or upon curing. Also, as used herein, the term “polymer” refers to prepolymers, oligomers, and both homopolymers and copolymers. The term “resin” may be used interchangeably with “polymer”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

The present disclosure is directed to a multi-layer coating system, comprising: a first coating layer formed from a first coating composition comprising: a film forming resin; and a fluorescent and/or phosphorescent pigment, wherein the fluorescent and/or phosphorescent pigment: (1) emits radiation at an emission wavelength in the range of from 400 to 1200 nanometers when excited by ultraviolet and/or visible radiation corresponding to an excitation wavelength of the fluorescent and/or phosphorescent pigment; and/or (2) emits radiation at an emission wavelength in the range of from 600 to 2500 nanometers when excited by visible and/or near infrared radiation corresponding to an excitation wavelength of the fluorescent and/or phosphorescent pigment; and a second coating layer disposed over at least a portion of the first coating layer, wherein the second coating layer is formed from a second coating composition comprising: a film forming resin; and a pigment that blocks radiation corresponding to the excitation and/or emission wavelength of the fluorescent and/or phosphorescent pigment in the first coating layer.

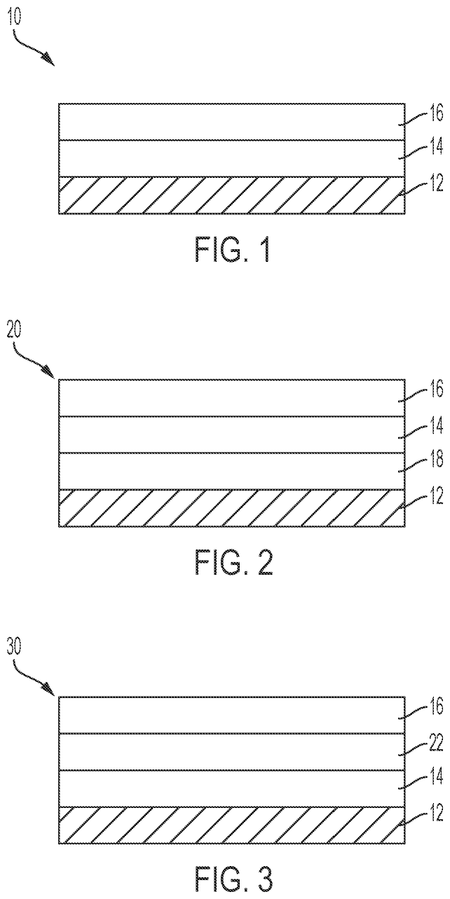

Referring to FIG. 1, a multi-layer coating system 10 is shown over a substrate 12, and the multi-layer coating system comprises a first coating layer 14, and a second coating layer 16.

The substrate 12 over which the multi-layer coating system 10 may be formed includes a wide range of substrates. For example, the multi-layer coating system 10 of the present disclosure can be formed over a vehicle substrate, including an aerospace substrate, an industrial substrate, and the like.

The vehicle substrate may include a vehicle or a component of a vehicle. In the present disclosure, the term “vehicle” is used in its broadest sense and includes all types of aircraft, spacecraft, watercraft, and ground vehicles. For example, the vehicle can include, but is not limited to an aerospace substrate (a component of an aerospace vehicle, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like). The vehicle can also include a ground vehicle such as, for example, animal trailers (e.g., horse trailers), all-terrain vehicles (ATVs), cars, trucks, buses, vans, heavy duty equipment, agricultural vehicles (e.g., tractors), golf carts, motorcycles, bicycles, snowmobiles, trains, railroad cars, and the like. The vehicle can also include watercraft such as, for example, ships, boats, hovercrafts, and the like. The vehicle substrate may include a component of the body of the vehicle, such as an automotive hood, door, trunk, roof, and the like; such as an aircraft or spacecraft wing, fuselage, and the like; such as a watercraft hull, and the like.

The multi-layer coating system 10 may be formed over an industrial substrate which may include tools, heavy duty equipment, agricultural machinery, furniture such as office furniture (e.g., office chairs, desks, filing cabinets, and the like), appliances such as refrigerators, ovens and ranges, dishwashers, microwaves, washing machines, dryers, small appliances (e.g., coffee makers, slow cookers, pressure cookers, blenders, etc.), metallic hardware, extruded metal such as extruded aluminum used in window framing, other indoor and outdoor metallic building materials, and the like.

The multi-layer coating system 10 may be formed over storage tanks, windmills, nuclear plant components, packaging substrates, wood flooring and furniture, apparel, electronics, including housings and circuit boards, glass and transparencies, sports equipment, including golf balls, stadiums, buildings, bridges, and the like.

The multi-layer coating system 10 may be formed over an infrastructure component, such as a bridge, a building, or the like.

The substrate 12 can be metallic or non-metallic. Metallic substrates include, but are not limited to, tin, steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel. Non-metallic substrates include polymeric materials, plastic and/or composite material, polyester, polyolefin, polyamide, cellulosic, polystyrene, polyacrylic, poly(ethylene naphthalate), polypropylene, polyethylene, nylon, ethylene vinyl alcohol (EVOH), polylactic acid, other “green” polymeric substrates, poly(ethyleneterephthalate) (PET), polycarbonate, polycarbonate acrylobutadiene styrene (PC/ABS), wood, veneer, wood composite, particle board, medium density fiberboard, cement, stone, glass, paper, cardboard, textiles, leather, both synthetic and natural, and the like. The substrate may comprise a metal, a plastic and/or composite material, and/or a fibrous material. The fibrous material may comprise a nylon and/or a thermoplastic polyolefin material with continuous strands or chopped carbon fiber. The substrate can be one that has already been treated in some manner, such as to impart visual and/or color effect, a protective pretreatment or other coating layer, and the like.

The multi-layer coating system 10 of the present disclosure may be particularly beneficial when formed over an aerospace substrate, such as an aircraft component. The multi-layer coating system 10 of the present disclosure may be particularly beneficial when formed over a component comprising aluminum or alloy thereof, a carbon fiber reinforced material, a composite material, and/or a combination thereof, such as an aerospace component formed from such material.

With continued reference to FIG. 1, the first coating layer 14 may be formed over at least a portion of the substrate 12. The first coating layer 14 may be formed directly over the substrate 12 so as to be in direct contact therewith without any intervening layers (as shown in FIG. 1). The first coating layer 14 may be formed indirectly over the substrate 12 such that at least one coating layer 18 is between the first coating layer 14 and the substrate 12 (see e.g., FIG. 2).

The first coating layer 14 may be formed from a first coating composition comprising a film forming resin and a fluorescent and/or phosphorescent pigment.

The film forming resin may include any of a variety of thermoplastic and/or thermosetting film forming resins known in the art. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. Once cured or crosslinked, a thermosetting resin will not melt upon the application of heat and is generally insoluble in solvents. As noted, the film forming resin may include a thermoplastic film forming resin. As used herein, the term “thermoplastic” refers to resins that include polymeric components that are not joined by covalent bonds and thereby can undergo liquid flow upon heating and can be soluble in solvents.

The film forming resin may comprise any of a variety of thermoplastic and/or thermosetting compositions known in the art. The coating composition(s) may be water-based or solvent-based liquid compositions, or, alternatively, in solid particulate form, i.e., a powder coating.

The first coating composition (or any other composition described herein) may comprise a one-component (1K) curing composition. As used herein, a “1K curing composition” refers to a composition wherein all the coating components are maintained in the same container after manufacture, during storage, and the like, and may remain stable for longer than 1 month at ambient conditions (60-85° F. (16-29° C.) at 0-95% relative humidity), such as longer than 3 months, longer than 6 months, longer than 9 months, or longer than 12 months. A 1K curing composition can be applied to a substrate and coalesced by any conventional means, such as by heating, forced air, and the like.

The first coating composition (or any other composition described herein) may be a multi-component composition, such as a two component composition (“2K”) or more, which has at least two components that are maintained in a different container after manufacture, during storage, etc. prior to application and formation of the coating over a substrate.

The film forming resin can be selected from, for example, epoxy polymers, amine-functional polymers, polyurethanes, fluoropolymers, polyester polymers, silicone modified polyester polymers, (meth)acrylic polymers, acrylic latex polymers, vinyl polymers, polyamides, polyethers, polysiloxanes, polysulfides, polythioethers, polyureas, copolymers thereof, and mixtures thereof. Generally, these polymers can be any polymers of these types made by any method known to those skilled in the art.

The film forming resin of the first coating composition may comprise an epoxy amine resin, such as a 2K epoxy amine resin. The film forming resin of the first coating composition may comprise a polyurethane resin.

The fluorescent and/or phosphorescent pigment of the first coating composition may comprise any suitable fluorescent and/or phosphorescent pigment known in the art. As used herein, a “fluorescent pigment” refers to a pigment that absorbs radiation at a first wavelength and, in response, emits radiation at a second wavelength different from the first wavelength. The second wavelength may have a lower energy (i.e., a longer wavelength) than the first wavelength. The fluorescent pigment will cease fluorescing nearly immediately (such as less than 1 millisecond) after removing the radiation source of the first wavelength. As used herein, a “phosphorescent pigment” refers to a pigment that follows a mechanism related to fluorescence except the phosphorescent pigment absorbs the incident radiation at the first wavelength and emits the radiation at the second wavelength for an extended period of time (such as for at least 1 millisecond, at least 1 minute, at least 10 minutes, at least 30 minutes, or at least 60 minutes) after removing the radiation source of the first wavelength.

The fluorescent and/or phosphorescent pigment may emit radiation at an emission wavelength in the range of from 400 to 1200 nanometers when excited by ultraviolet and/or visible radiation corresponding to an excitation wavelength of the fluorescent and/or phosphorescent pigment. As used herein, “excitation wavelength” refers to the wavelength(s) of the incident radiation at which the pigment is caused to fluoresce and/or phosphoresce when irradiated thereby. As used herein, “emission wavelength” refers to the wavelength(s) of the radiation fluoresced and/or phosphoresced by the pigment in response to irradiation at the excitation wavelength. Ultraviolet radiation comprises radiation having a wavelength of from 10 nm to less than 400 nm. Visible radiation comprises radiation having a wavelength from 400 nm to 700 nm. Infrared radiation comprises radiation having a wavelength from greater than 700 nm to 1 mm. Near infrared radiation comprises radiation having a wavelength from greater than 700 nm to 2500 nm. Thus, the fluorescent and/or phosphorescent pigment may emit radiation in the visible, and/or infrared region when excited by ultraviolet and/or visible radiation corresponding to an excitation wavelength of the fluorescent and/or phosphorescent pigment. The fluorescent and/or phosphorescent pigment may emit radiation at an emission wavelength in the range of from 400 to 700 nanometers (the visible region) when excited by ultraviolet and/or visible radiation corresponding to an excitation wavelength of the fluorescent and/or phosphorescent pigment.

Non-limiting examples of fluorescent pigments that may emit radiation at an emission wavelength in the range of from 400 to 1200 nanometers and/or from 400 to 700 nanometers when excited by ultraviolet and/or visible radiation include molecules such as those with a cyanine, perylene, coumarin, xanthene, thioxanthene, quinone, anthraquinone, indigoid, thioindigoid, thiophene, or stilbene structure which may be encapsulated in a thermoset resin for stability.

Non-limiting examples of phosphorescent pigments that may emit radiation at an emission wavelength in the range of from 400 to 1200 nanometers and/or from 400 to 700 nanometers when excited by ultraviolet and/or visible radiation include a zinc sulfide structure with substitution of the zinc and activation by various elemental activators; strontium aluminate phosphors doped with transition metals such as europium, dysprosium, or terbium; cerium magnesium aluminate phosphors doped with transition metals such as terbium; or yttrium oxide phosphors doped with europium.

The fluorescent and/or phosphorescent pigment may emit radiation at an emission wavelength in the range of from 600 to 2500 nanometers when excited by visible and/or near infrared radiation corresponding to an excitation wavelength of the fluorescent and/or phosphorescent pigment. Thus, the fluorescent and/or phosphorescent pigment may emit radiation in the visible and/or infrared region when excited by visible and/or near infrared radiation corresponding to an excitation wavelength of the fluorescent and/or phosphorescent pigment. The fluorescent and/or phosphorescent pigment may emit radiation at an emission wavelength in the range of from greater than 700 to 2500 nanometers (the near infrared region) when excited by visible and/or near infrared radiation corresponding to an excitation wavelength of the fluorescent and/or phosphorescent pigment.

Non-limiting examples of fluorescent pigments that may emit radiation at an emission wavelength in the range of from 600 to 2500 nanometers and/or from greater than 700 to 2500 nanometers when excited visible and/or near infrared radiation include certain metallic pigments, metal oxides, mixed metal oxides, metal sulfides, metal selenides, metal tellurides, metal silicates, inorganic oxides, inorganic silicates, alkaline earth metal silicates. As used herein, the term “alkaline” or “alkaline earth metal” refers to the elements of group II of the periodic table Be, Mg, Ca, Sr, Ba, and Ra (beryllium, magnesium, calcium, strontium, barium, radium). Non-limiting examples of suitable fluorescent pigments may include certain metal compounds, which may be doped with one or more metals, metal oxides, and alkali and/or rare earth elements. As used herein, the term “alkali” or “alkali metal” refers to the elements of group I of the periodic table Li, Na, K, Rb, Cs, and Fr (lithium, sodium, potassium, rubidium, cesium, and francium). As used herein, the term “rare earth element” refers to the lanthanide series of elements La, Ce, Pr, Nd, Pm, Sm, Eu, Gd, Tb, Dy, Ho, Er, Tm and Yb (lanthanum, cerium, praseodymium, neodymium, promethium, samarium, europium, gadolinium, terbium, dysprosium, holmium, erbium, thulium, ytterbium).

Further non-limiting examples of fluorescent pigments that may emit radiation at an emission wavelength in the range of from 600 to 2500 nanometers and/or the near infrared region when excited visible and/or near infrared radiation include Egyptian blue (CaCuSi₄O₁₀), Han blue (BaCuSi₄O₁₀), Han purple (BaCuSi₂O₆), SrCuSi₄O₁₀, ruby (Al₂O₃:Cr), Sr(La, Li)CuSi₄O₁₀, and Ba(La, Li)CuSi₄O₁₀. In particular, blue alkali earth copper silicates, such as Egyptian blue (CaCuSi₄O₁₀) fluoresce in the 800 to 1200 nm region. Cadmium-containing pigments, CdSe and CdTe compounds, “zirconia” red (red cadmium pigments coated with a zirconium silicate glass), indigo, copper blue, azurite (Cu₃(CO₃)₂(OH)₂), ploss blue ((CuCa)(CH₃COO)₂·2H₂O), and smalt (COO·K·Si) may fluoresce.

Further non-limiting examples of fluorescent pigments that may emit radiation at an emission wavelength in the range of from 600 to 2500 nanometers and/or the near infrared region when excited visible and/or near infrared radiation include ZnO, ZnS, ZnSe, ZnTe, Zn(O,S,Se,Te). These fluorescent pigments have energy gaps that are too large for band-to-band emission of IR energy, but doping with Sn, Mn, and Te can lead to suitable impurity luminescence. Other non-limiting examples include compounds used in lighting and for fluorescent displays; certain direct bandgap semiconductors, such as (Al,Ga)As, InP, and the like; and materials used for solid state lasers, such as Nd doped yttrium aluminum garnet, and titanium doped sapphire.

Non-limiting examples of phosphorescent pigments that may emit radiation at an emission wavelength in the range of from 600 to 2500 nanometers and/or from greater than 700 to 2500 nanometers when excited by visible and/or near infrared radiation include phosphors that emit in the deep red or infrared region (e.g., LiAlO₂:Fe, CaS:Yb).

The fluorescent and/or phosphorescent pigment included in the first coating composition may be selected so as to have an excitation wavelength compatible with the wavelength emitted by a radiation source directed at the multi-layer coating system 10 and have an emission wavelength compatible with the wavelength detectable by a radiation detector positioned to detect radiation emitted from the multi-layer coating system 10. An excitation wavelength “compatible with” the wavelength emitted by a radiation source means a wavelength of radiation which, if incident to the fluorescent and/or phosphorescent pigment causes a fluorescing and/or phosphorescing response therefrom. An emission wavelength “compatible with” the wavelength detectable by a radiation detector means a wavelength of radiation which, if emitted by the fluorescent and/or phosphorescent pigment and incident to the radiation detector, is detectable thereby. The fluorescent and/or phosphorescent pigment included the first coating composition may be selected so as to have an excitation wavelength and/or emission wavelength incompatible with the later described second coating layer 16 so that radiation at such wavelengths may be at least partially blocked by the second coating layer 16.

The radiation emitted by the first coating layer 14 at the emission wavelength may comprise a wavelength (e.g., in the visible region) and have a sufficient intensity so as to be visible to a naked human eye positioned to see the multi-layer coating system 10. The radiation emitted by the first coating layer 14 at the emission wavelength may comprise a wavelength (e.g., within the detection band of the radiation detector) and have a sufficient intensity so as to be detected by a non-human radiation detector device positioned to detect radiation emitted from the multi-layer coating system 10, such as an infrared camera and/or an ultraviolet-visible-infrared spectrophotometer. Non-limiting examples of non-human radiation detectors comprise a PerkinElmer LAMBDA 1050+UV/Vis/NIR spectrophotometer or a Zohulu HD digital video camera 1080P (1920×1080), 24 Megapixel, with night vision. The first coating composition may include the fluorescent and/or phosphorescent pigment in an effective amount so as to have an emission wavelength and/or sufficient intensity so as to be detected by the naked human eye and/or the non-human radiation detector device.

The first coating composition may further comprise a corrosion inhibitor. The corrosion inhibitor may comprise an inorganic component. As used herein, a “corrosion inhibitor” refers to a component such as a material, substance, compound, or complex that reduces the rate or severity of corrosion of a surface on a metal or metal alloy substrate. The inorganic component that acts as a corrosion inhibitor can include, but is not limited to, an alkali metal component, an alkaline earth metal component, a transition metal component, and/or a combination thereof. The term “transition metal” refers to an element of Groups 3 through 12 (IUPAC) of the periodic table of the chemical elements, and includes, e.g., titanium (Ti), Chromium (Cr), and zinc (Zn), among various others. The corrosion inhibitor may comprise magnesium oxide.

The first coating composition may include a tinting pigment. As used herein, a “tinting pigment” refers to a pigment which absorbs, scatters, and/or reflects incoming visible radiation to alter the visible color of the coating layer while not fluorescing or phosphorescing the incident radiation would be characteristic of fluorescent or phosphorescent pigments. As such, tinting pigments are distinguishable from the fluorescent and phosphorescent pigments. These tinting pigments may serve at least one function in the coating, such as providing corrosion resistance, conductivity, and/or color tinting or imparting.

Non-limiting examples of tinting pigments comprise titanium dioxide (TiO₂), phthalocyanine pigments that may be substituted with a number of halogen groups (bromide or chloride) to shift color, carbon black, or insoluble effect pigments such as aluminum flakes.

Alternatively, the first coating composition may be substantially free, essentially free, or completely free of a tinting pigment. As used herein, the phrase “substantially free of a tinting pigment” means that the coating composition comprises less than 5 weight % of a tinting pigment, based on total solids of the coating composition. As used herein, the phrase “essentially free of a tinting pigment” means that the coating composition comprises less than 1 weight % of a tinting pigment, based on total solids of the coating composition. As used herein, the phrase “completely free of a tinting pigment” means that the coating composition comprises 0 weight % of a tinting pigment, based on total solids of the coating composition.

The first coating layer 14 may be formed over the substrate 12 as a primer coating layer. A “primer coating layer” refers to an undercoating that may be deposited onto a substrate (e.g., directly or over a pre-treatment) in order to prepare the surface for application of a protective or decorative coating system. Thus, the first coating composition may comprise a primer coating composition which may be applied to form a primer coating layer.

The first coating composition may comprise a primer composition, such as a commercially available primer that has been reformulated to comprise the fluorescent and/or phosphorescent pigment as previously described. Such primers may also reformulated to further improve performance by removing some or all of the tinting pigments contained therein, such that the reformulated primer comprises the fluorescent and/or phosphorescent pigment and is substantially free, essentially free, or completely free of tinting pigments. Non-limiting examples of primer compositions that may be reformulated included those marketed under the tradename DESOPRIME (commercially available from PPG Industries, Inc. (Pittsburgh, PA)) or the following primers commercially available from PPG Industries, Inc.: 02GN084, 02GN093, 02W053, 02Y040A.

With continued reference to FIG. 1, the second coating layer 16 may be formed over at least a portion of the first coating layer 14. The second coating layer 16 may be formed directly over the first coating layer 14 so as to be in direct contact therewith without any intervening layers (as shown in FIGS. 1, 2, and 4). The second coating layer 16 may be formed indirectly over the first coating layer 14 such that at least one coating layer 22 intervenes with the second coating layer 16 and the first coating layer 14 (see e.g., FIG. 3).

The second coating layer 16 may be formed from a second coating composition comprising a film forming resin and a pigment.

The film forming resin of the second coating composition may comprise any of the film forming resins (or characteristics thereof) described in connection with the first coating composition.

The pigment of the second coating composition (also referred to herein as the “blocking pigment”) may comprise at least one pigment that blocks radiation corresponding to the excitation and/or emission wavelength of the fluorescent and/or phosphorescent pigment in the first coating layer 14, such that the second coating layer 16 blocks radiation corresponding to the excitation and/or emission wavelength of the fluorescent and/or phosphorescent pigment in the first coating layer 14. The blocking pigment may absorb and/or reflect the radiation corresponding to the excitation and/or emission wavelength of the fluorescent and/or phosphorescent pigment in the first coating layer 14 as the “blocking” mechanism. As such, the blocking pigment may comprise a visibly absorbing and/or reflecting and/or an infrared absorbing and/or reflecting pigment, including a near infrared absorbing and/or reflecting pigment.

The second coating layer 16 comprising the blocking pigment of the second coating composition may block (e.g., be opaque to) substantially all of the incident radiation corresponding to the excitation and/or emission wavelength of the fluorescent and/or phosphorescent pigment in the first coating layer 14, such as at least 90%, 95%, or 99% thereof. The second coating layer comprising the blocking pigment of the second coating composition may completely block the incident radiation corresponding to the excitation and/or emission wavelength of the fluorescent and/or phosphorescent pigment in the first coating layer 14, such that 100% of the incident radiation is blocked. An effective amount of the blocking pigment may be included in the second coating composition so as to block all or substantially all of the incident radiation corresponding to the excitation and/or emission wavelength of the fluorescent and/or phosphorescent pigment in the first coating layer 14.

The second coating layer 16 comprising the blocking pigment of the second coating composition may block (e.g., be opaque to) an effective percent of radiation incident to the second coating layer 16 and corresponding to the emission wavelength of the fluorescent and/or phosphorescent pigment in the first coating layer 14, such that any of the incident radiation corresponding to the emission wavelength of the fluorescent and/or phosphorescent pigment in the first coating layer 14 transmitted through the second coating layer 16 is below a sensitivity threshold of the radiation detector (previously described). An effective amount of the blocking pigment may be included in the second coating composition so as to block an effective percent of radiation incident to the second coating layer below a sensitivity threshold of the radiation detector.

Non-limiting examples of the blocking pigment include titanium dioxide (TiO₂), phthalocyanine pigments that may be substituted with a number of halogen groups (bromide or chloride) to shift color, iron oxide (Fe₂O₃), carbon black, or insoluble effect pigments such as aluminum flakes.

The second coating composition may comprise a visibly opaque pigment which may be the same or different from the blocking pigment. The visibly opaque pigment may be included in the second coating composition in an effective amount such that the second coating layer 16 is visibly opaque. As used herein, a coating layer being “visibly opaque” means that the naked human eye is not capable of seeing through the visibly opaque layer, such that any substrate or underlayer thereunder is not visible to the naked human eye.

The second coating layer 16 may form a topcoat layer of the multi-layer system 10 (see e.g., FIG. 1). As used herein, a “topcoat layer” refers to an outermost coating layer of a coated substrate.

The second coating layer 16 may be transparent at the excitation and/or emission wavelength of the fluorescent and/or phosphorescent pigment in the first coating layer 14 but not at both. As such, the second coating layer 16 coating layer may block radiation at the excitation and/or emission wavelength of the fluorescent and/or phosphorescent pigment in the first coating layer 14, which is affected by at least the blocking pigment. The second coating layer 16 may block an effective amount of the radiation at the excitation and/or emission wavelength of the fluorescent and/or phosphorescent pigment in the first coating layer 14 such that the radiation at the excitation and/or emission wavelength that may incidentally transmit through the second coating layer 16 is at an intensity not detectable by the radiation detector.

With continued reference to FIG. 1, the multi-layer coating system 10 shown therein comprises a first coating layer 14 formed over and in direct contact with the substrate 12 and a second coating layer 16 formed over and in direct contact with the first coating layer 14, with the second coating layer 16 being the topcoat layer. The second coating layer 16 may completely cover the first coating layer 14 so that no signal is emitted at the emission wavelength from the first coating layer 14 if the multi-layer coating system 10 is not damaged (e.g., damage being indicated by at least partial exposure of the first coating layer 14).

With continued reference to FIG. 1, the multi-layer coating system 10 may be prepared by applying the first coating composition over (directly or indirectly) the substrate 12 and coalescing the first coating composition to form the first coating layer 14. The term “coalesce” refers to the process by which a coating composition hardens to form a coating layer. Coalescing may include the coating composition being cured (e.g., hardening by being crosslinked, either by itself or via a crosslinking agent) or the coating composition being dried. The second coating composition may be applied over (directly or indirectly) at least a portion of the first coating composition and/or the first coating layer 14 and coalesced to form the second coating layer 16.

The first coating composition and/or the second coating composition may be applied using any suitable application technique. For example, the coating composition may be applied by spraying, electrostatic spraying, electrocoating, dipping, rolling, brushing, and the like.

The second coating layer 16 may be formed over the first coating layer 14 at a sufficient thickness so as to block an effective percent of the radiation at the excitation and/or emission wavelength of the fluorescent and/or phosphorescent pigment in the first coating layer 14 such that the radiation at the excitation and/or emission wavelength that may incidentally transmit through the second coating layer 16 is at an intensity not detectable by the radiation detector.

The first coating composition may be applied over the substrate 12 and coalesced to form the first coating layer 14 prior to application of the second coating composition, which may be subsequently applied over the first coating layer 14 and coalesced to form the second coating layer 16. Alternatively, the first coating composition may be applied over the substrate 12 followed by the second coating composition be applied over the first coating composition (prior to coalescing the first coating composition), and subsequently coalescing the first and second coating compositions simultaneously to form the first coating layer 14 and the second coating layer 16.

It will be appreciated that additional coating layers and other modifications may be made to the multi-layer coating system 10 shown in FIG. 1 that are within the scope of the present disclosure.

Referring to FIG. 2, a multi-layer coating system 20 is shown which is similar to the multi-layer coating system 10 from FIG. 1 but different in the following ways. In the multi-layer coating system 20 of FIG. 2, the first coating layer 14 is no longer in direct contact with the substrate 12, and a primer or other coating layer 18 formed from a coating composition may intervene the substrate 12 and the first coating layer 14. The primer coating composition may be any suitable primer composition suitable to “prime” the substrate for the first coating layer 14, such as to improve adhesion between the substrate 12 and the first coating layer 14. Additional coating layers may intervene the substrate 12 and the first coating layer 14.

With continued reference to FIG. 2, the primer coating composition may be applied over (directly or indirectly) the substrate 12 using any of the previously described application techniques and coalesced to form the primer coating layer 18. The primer coating composition may be separately coalesced from the first coating composition and/or the second coating composition such that the first coating composition is applied over the primer coating layer 18. Alternatively, the primer coating composition may be simultaneously coalesced with any of the first coating composition and the second coating composition.

Referring to FIG. 3, a multi-layer coating system 30 is shown that is similar to the multi-layer coating system 10 from FIG. 1 but different in the following ways. In the multi-layer coating system 30 of FIG. 3, the first coating layer 14 is no longer in direct contact with the second coating layer 16, and an intermediate coating layer 22 (or multiple intermediate layers) formed from an intermediate coating composition is formed between at least a portion of the second coating layer 16 and the first coating layer 14. The intermediate coating layer 22 may be an adhesion promoting layer comprising an adhesion promotor, to enhance the adhesion between the first coating layer 14 and the second coating layer 16. The adhesion promoting layer may be silane-based. The intermediate coating layer 22 may be an intercoat layer included to enhance at least one property and/or appearance of the multi-layer system 30. The intermediate coating layer 22 may be formulated similar to the second coating layer 16 by including a blocking pigment which blocks radiation corresponding to the excitation and/or emission wavelength of the fluorescent and/or phosphorescent pigment in the first coating layer 14.

With continued reference to FIG. 3, the intermediate coating composition may be applied over (directly or indirectly) the substrate 12 and/or the first coating composition or first coating layer 14 using any of the previously described application techniques and coalesced to form the intermediate coating layer 22. The intermediate coating composition may be separately coalesced from the first coating composition and/or the second coating composition such that the second coating composition is applied over the intermediate coating layer 22. Alternatively, the intermediate coating composition may be simultaneously coalesced with any of the first coating composition and the second coating composition.

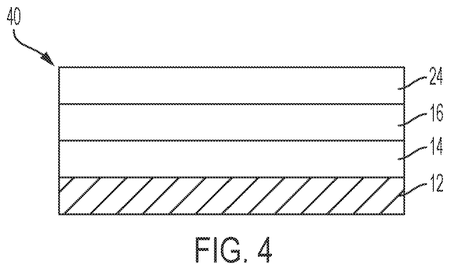

Referring to FIG. 4, a multi-layer coating system 40 is shown which is similar to the multi-layer coating system 10 from FIG. 1 but different in the following ways. In the multi-layer coating system 40 of FIG. 4, an additional coating layer is included (compared to the multi-layer coating system 10 from FIG. 1) with a clearcoat coating layer 24 formed over at least a portion of the second coating layer 16. The clearcoat coating layer 24 may be the topcoat layer of the multi-layer coating system 40. The clearcoat coating layer 24 may be at least partially transparent in the visible region such that at least a portion of the layer(s) beneath the clearcoat coating layer 24 are visible to the naked human eye. The clearcoat coating layer 24 may be formed from a clearcoat coating composition as a protective coating layer of the multi-layer coating system 40. The clearcoat coating layer 24 may impart a physical and/or appearance property to the multi-layer coating system 40.

With continued reference to FIG. 4, the clearcoat coating composition may be applied over (directly or indirectly) the substrate 12 and/or the second coating composition or second coating layer 16 using any of the previously described application techniques and coalesced to form the clearcoat coating layer 24. The clearcoat coating composition may be separately coalesced from the first coating composition and/or the second coating composition such that the clearcoat coating composition is applied over the second coating layer 16. Alternatively, the clearcoat coating composition may be simultaneously coalesced with any of the first coating composition and the second coating composition.

The various coating compositions described herein, such as the first coating composition, the second coating composition, and the like can include other additive components, such as plasticizers, abrasion resistant particles, fillers, antioxidants, hindered amine light stabilizers, ultraviolet light absorbers and stabilizers, flow and surface control agents, thixotropic agents, reaction inhibitors, degassing agents, and other customary auxiliaries.

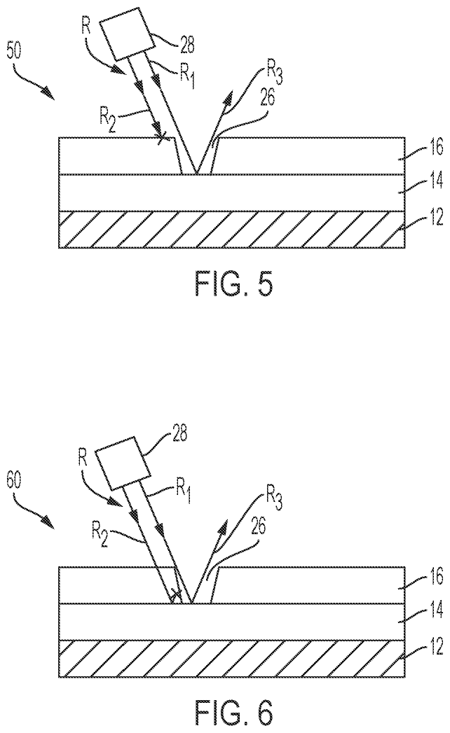

Referring to FIGS. 5 and 6, systems are shown for detecting a damaged region of a coating layer and/or a coated substrate. These examples show the system including a multi-layer coating system as shown and described in FIG. 1; however, the system may include any of the examples of the multi-layer coating systems shown and described herein (see e.g., FIGS. 2-4).

Referring to FIG. 5, a multi-layer coating system 50 is shown over a substrate 12, and the multi-layer coating system 50 comprises the first coating layer 14 formed over the substrate 12, and the second coating layer 16 formed over the first coating layer 14. The second coating layer 16 may comprise a damaged region 26 in which at least a portion of the second coating layer 16 is thinned from its original thickness and/or at least a portion of the first coating layer 14 is exposed. The damaged region 26 may comprise damage in the form of a chipped, cracked, bent, deformed, scratched, and/or thinned portion of the second coating layer 16. At least a portion of the first coating layer 14 may be exposed in the damaged region 26. The damaged region 26 may comprise micro-sized damage. The damaged region 26 may comprise damage having a length and/or width in a direction of at least 50 μm.

With continued reference to FIG. 5, the system for detecting the damaged region 26 may comprise a radiation source 28 configured and positioned to direct radiation R at the multi-layer coating system 50, including the damaged region 26. The radiation R from the radiation source 28 may be directed at the multi-layer coating system 50 and emitted at the excitation wavelength of the fluorescent and/or phosphorescent pigment from the first coating layer 14. The excitation wavelength may be any of the excitation wavelengths previously described. The radiation source 28 may be positioned so as to direct radiation R₁ at the excitation wavelength such that it is incident to an exposed portion of the first coating layer 14 within the damaged region 26. Upon incident radiation R₁ at the excitation wavelength irradiating the first coating layer 14 (e.g., the fluorescent and/or phosphorescent pigment therein), radiation R₃ may be emitted (e.g., fluoresced and/or phosphoresced) at the emission wavelength of the fluorescent and/or phosphorescent pigment from the first coating layer 14. The emission wavelength may be any of the emission wavelengths previously described.

The radiation source 28 may be any radiation source capable of directing radiation R at the excitation wavelength at a sufficient enough intensity such that the first coating layer may emit radiation at the emission wavelength at a sufficient intensity so as to be detected by a radiation detector. The radiation source 28 may emit ultraviolet radiation, visible radiation, and/or infrared radiation at the excitation wavelength. The radiation source 28 may comprise a flashlight emitting ultraviolet radiation, visible radiation, and/or infrared radiation. The radiation source 28 may comprise an array of ultraviolet light emitting diodes (LEDs). The radiation source 28 may comprise a controlled lighting booth emitting ultraviolet radiation, such as UVA radiation (from 315 to less than 400 nm). The radiation source 28 may comprise a radiation source contained within an infrared camera and/or night vision goggles.

With continued reference to FIG. 5, at least a portion of the radiation R₂ emitted from the radiation source 28 may not be incident to the damaged region 26, such as the exposed first coating layer 14 therein. At least a portion of the radiation R₂ emitted from the radiation source 28 may be incident to the second coating layer 16. As previously described, the second coating layer 16 may be formed from a second coating composition comprising the blocking pigment that blocks radiation R₂ corresponding to the excitation wavelength of the fluorescent and/or phosphorescent pigment in the first coating layer 14. Thus, the second coating layer 16 may block (as shown) the radiation R₂ emitted from the radiation source 28 at the excitation wavelength from reaching the first coating layer 14 covered thereby, such that covered regions of the first coating layer 14 (undamaged regions of the multi-layer coating system 50) do not emit radiation at the emission wavelength. This enables damaged regions 26 of the multi-layer coating system 50 to emit a signal at the emission wavelength indicating that the region is damaged while the undamaged regions of the multi-layer coating system 50 do not emit a signal at the emission wavelength. As such, a detector (not shown) having sensitivity at the emission wavelength may detect the damaged regions 26 and/or differentiate the damaged regions 26 from the undamaged regions.

Referring to FIG. 6, a multi-layer coating system 60 is shown which is identical to the multi-layer coating system 50 from FIG. 5 except as described hereinafter.

As in FIG. 5, in FIG. 6 at least a portion of the radiation R₂ emitted from the radiation source 28 may not be incident to the damaged region 26, such as the exposed first coating layer 14 therein. At least a portion of the radiation R₂ emitted from the radiation source 28 may be incident to the second coating layer 16. As previously described, the second coating layer 16 may be formed from a second coating composition comprising the blocking pigment that blocks radiation R₂ corresponding to the emission wavelength of the fluorescent and/or phosphorescent pigment in the first coating layer 14. Thus, the second coating layer 16 may be transparent to radiation R₂ emitted at the excitation wavelength from the radiation source 28; however, the second coating layer 16 (e.g., the underside thereof) may block (as shown) the radiation emitted from first coating layer 14 at the emission wavelength from reaching the radiation detector (not shown), such that covered regions of the first coating layer 14 (undamaged regions of the multi-layer coating system 60) do not emit radiation at the emission wavelength that reaches the radiation detector. This enables damaged regions 26 of the multi-layer coating system 60 to emit a signal at the emission wavelength indicating that the region is damaged while the undamaged regions of the multi-layer coating system 60 do not emit a signal at the emission wavelength that reaches the radiation detector. As such, the detector having sensitivity at the emission wavelength may detect the damaged regions 26 and/or differentiate the damaged regions 26 from the undamaged regions.

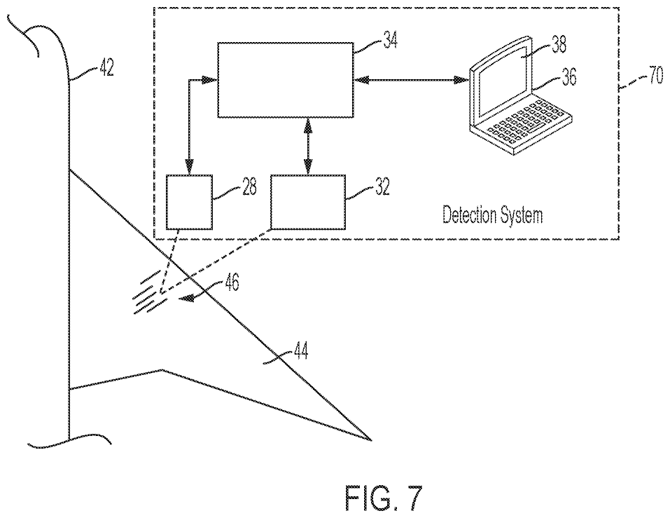

Referring to FIG. 7, a detection system 70 is shown for detecting a damaged region of a coated substrate. The detection system 70 may include the radiation source 28. The detection system 70 may include a radiation detector 32. The detection system 70 may include a detection processor 34. The detection system 70 may include a computing device 36, which may comprise a display 38.

The detection system 70 may be used to detect a damaged region of a coated substrate (coated with a multi-layer coating system described herein), which may be any coated substrate, such as any of the previously described substrates. In FIG. 7, the coated substrate comprises a coated vehicle, such as an aircraft 42 over which the multi-layer coating system has been applied and at least a portion of which is damaged such that at least a portion of the first coating layer having the fluorescent and/or phosphorescent pigment is exposed. The aircraft 42 may include a wing 44 that is coated with the multi-layer coating system, although the present disclosure may be suitable for any aircraft component or any vehicle or vehicle component. The wing 44 may have a damaged region 46, such as the scratches shown in FIG. 7. It will be appreciated that the components of FIG. 7 are not drawn to scale, and the scratches of the damaged region 46 may instead be undetectable to a naked human eye without the detection system of the present disclosure.

With continued reference to FIG. 7, the detection system 70 may include the radiation source 28 as previously described. The radiation detector 32 may include any detector capable of detecting radiation at the emission wavelength emitted by the fluorescent and/or phosphorescent pigment of the first coating layer (not shown) exposed in the damaged region 46. The radiation detector 32 may be capable of detecting ultraviolet, visible, and/or infrared radiation.

The radiation detector 32 may be a naked human eye. As such, the radiation emitted by the fluorescent and/or phosphorescent pigment of the first coating layer exposed in the damaged region 46 may be visible radiation with sufficient intensity to be detectable by a naked human eye. This allows an individual, such as a maintenance associate, to identify damaged regions 46 of the coated substrate with the radiation source 28 and without specialized radiation detection equipment.

The radiation detector 32 may comprise a device. For example, the radiation detector 32 may comprise an infrared camera and/or an ultraviolet-visible-infrared spectrophotometer.

Referring to FIG. 7, the radiation source 28 and the radiation detector 32 are shown as separate devices. However, it will be appreciated that the radiation source 28 and the radiation detector 32 may be integrated into the same device.

With continued reference to FIG. 7, a method for detecting the damaged region 46 of the coated substrate using the detection system 70 includes detecting radiation emitted from the fluorescent and/or phosphorescent pigment of the partially exposed first coating layer of the damaged region 46. The radiation source 28 may direct radiation at the excitation wavelength of the fluorescent and/or phosphorescent pigment of the first coating layer and detect radiation incident to the exposed portion of the first coating layer (in the damaged region 46) which is emitted via fluorescence and/or phosphorescence at the emission wavelength. The radiation detector 32 may detect this emitted radiation at the emission wavelength.

Based on the detected radiation emitted from the first coating layer of the damaged region 46, the method may include identifying (e.g., with the detection system 70), the damaged region 46 of the multi-layer coating system over the coated substrate.

The damaged region 46 may be identified manually by a user identifying by human eye (e.g., as the radiation detector 32) the portions of the coated substrate emitting a signal at the emission wavelength in the visible region indicating a damaged region 46. The damaged region 46 may be identified manually by a user interpreting data, such as numerical and/or graphical data generated by a device which corresponds to a signal indicating a damaged region 46. For example, a user may interpret an image generated using a radiation detector 32 device such as an infrared camera (e.g., a night vision camera) to identify the signal indicating a damaged region 46. In such example, the radiation detector 32 may communicate with a detection processor 34 which may receive and analyze the received data. The detection processor may generate an output and communicate the output to the computing device 36 to cause the computing device 36 to display on the display 38 the data to be interpreted by the user. For example, the detection processor 34 may generate an image to be displayed on the display 38 such that the user may interpret the image to identify the damaged region 46.

With continued reference to FIG. 7, the damaged region 46 may be identified automatically by the detection processor 34. The detection processor 34 may receive and analyze the received data from the radiation detector 32. Based on this data, the detection processor 34 may automatically determine regions of the coated substrate that correspond to the damaged regions 46. For example, the detection processor 34 may generate an image based on the data and automatically identify regions of the image corresponding to the damaged regions 46. The detection processor 34 may communicate the image having data generated by the detection processor 34 identifying the damaged regions 46 of the substrate to the computing device 36 which may be displayed on the display 38. As such, the image on the display 38 may automatically identify for the user the damaged regions 46 of the coated substrate.

Identifying the damaged region 46 may help the user identify component maintenance and/or replacement steps to enhance the safety associated with using the coated substrate. For example, the existence of the damaged region 46 may be an early indicator of impending component failure such that the component can be repaired and/or replaced prior to failure thereof, and/or it may indicate damage that has already been done, such as through impact.

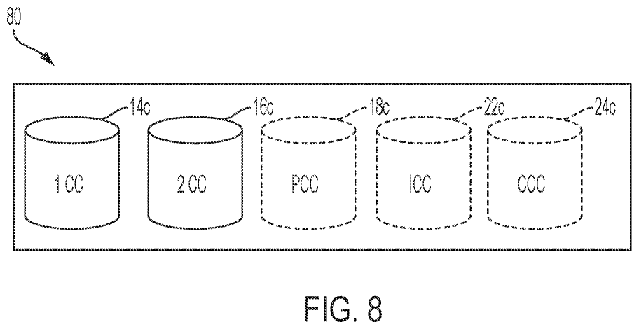

Referring to FIG. 8, a kit 80 is shown for forming a multi-layer coating system as described herein. The kit 80 may include a plurality of separate containers 14c, 16c, 18c, 22c, 24c with each container comprising a separate composition for forming a different layer in the multi-layer coating system. The kit 80 may include a plurality of separate containers 14c, 16c, 18c, 22c, 24c with each container containing a different composition compared to any of the other compositions in the separate containers 14c, 16c, 18c, 22c, 24c. The separate containers 14c, 16c, 18c, 22c, 24c may be packaged and/or sold together as a kit 80 with which a user may form the multi-layer coating system. The user may apply each composition sold in the kit to a substrate and coalesce each composition to form the coating layers. The kit may also be used in the repair of a damaged coating.

The kit 80 may include a first container 14c comprising any of the first coating compositions as previously described. For example, the first coating composition may comprise the a film forming resin and the fluorescent and/or phosphorescent pigment which: (1) emits radiation at an emission wavelength in the range of from 400 to 1200 nanometers when excited by ultraviolet and/or visible radiation corresponding to an excitation wavelength of the fluorescent and/or phosphorescent pigment and/or (2) emits radiation at an emission wavelength in the range of from 600 to 2500 nanometers when excited by visible and/or near infrared radiation corresponding to an excitation wavelength of the fluorescent and/or phosphorescent pigment. The first coating composition may be applied over the substrate and coalesced to form the first coating layer (e.g., the first coating layer 14 from FIGS. 1-4) as previously described.

The kit 80 may include a second container 16c comprising any of the second coating compositions as previously described. For example, the second coating composition may comprise the film forming resin and the pigment that blocks radiation corresponding to the excitation and/or emission wavelength of the fluorescent and/or phosphorescent pigment in the first coating layer. The second coating composition may be applied over the substrate and/or over the first coating layer and coalesced to form the second coating layer (e.g., the second coating layer 16 from FIGS. 1-4) as previously described.

The kit 80 may optionally include a third container 18c comprising any of the primer coating compositions as previously described. The primer coating composition may be applied over the substrate and coalesced to form the primer coating layer (e.g., the primer coating layer 18 from FIG. 2) as previously described.

The kit 80 may optionally include a fourth container 22c comprising any of the intermediate coating compositions as previously described. The intermediate coating composition may be applied over the substrate and/or over the first coating layer and coalesced to form the intermediate coating layer (e.g., the intermediate coating layer 22 from FIG. 3) as previously described.

The kit 80 may optionally include a fifth container 24c comprising any of the clearcoat coating compositions as previously described. The clearcoat coating composition may be applied over the substrate and/or over the first coating layer and/or over the second coating layer and coalesced to form the clearcoat coating layer (e.g., the clearcoat coating layer 24 from FIG. 4) as previously described.

It will be appreciated that the multi-layer coating systems described herein may be used to detect a damaged region of a coated substrate as described herein.

### EXAMPLES

The following examples are presented to demonstrate the general principles of the disclosure. The disclosure should not be considered as limited to the specific examples presented.

### Examples 1-10

### UV Fluorescent or Phosphorescent Primers/Interlayers

The following materials were used in Examples 1-10.

TABLE 1

| Component | Supplier |
|---|---|
| DESOPRIME HS CA7700 Epoxy | PPG Industries, Inc. |
| Primer Base Component | (Pittsburgh, PA) |
| DESOPRIME HS CA7700B | PPG Industries, Inc. |
| Activator Component | (Pittsburgh, PA) |
| DESOPRIME CF/CA7502E Chrome Free | PPG Industries, Inc. |
| Epoxy Primer Base Component | (Pittsburgh, PA) |
| DESOPRIME CF/CA7502EB Activator | PPG Industries, Inc. |
| Component | (Pittsburgh, PA) |
| DESOPRIME CF/CA7502EC Thinner | PPG Industries, Inc. |
| Component | (Pittsburgh, PA) |
| DESOTHANE HS CA8000/S115 Clear | PPG Industries, Inc. |
| Polyurethane Base Component | (Pittsburgh, PA) |
| DESOTHANE HS CA8000B Activator | PPG Industries, Inc. |
| Component | (Pittsburgh, PA) |
| DESOTHANE HS CA8000C Thinner | PPG Industries, Inc. |
| Component | (Pittsburgh, PA) |
| DESOTHANE HS CA 9007 BAC70846 White | PPG Industries, Inc. |
| Polyurethane Base Component | (Pittsburgh, PA) |
| DESOTHANE HS CA9007B Activator | PPG Industries, Inc. |
| Component | (Pittsburgh, PA) |
| DESOTHANE HS CA9311/F36170 Advanced | PPG Industries, Inc. |
| Performance Polyurethane Topcoat Base | (Pittsburgh, PA) |
| DESOTHANE HS CA9311/F37038 Advanced | PPG Industries, Inc. |
| Performance Polyurethane Topcoat Base | (Pittsburgh, PA) |
| DESOTHANE HS CA9311B Activator | PPG Industries, Inc. |
| Component | (Pittsburgh, PA) |
| 2K Epoxy/Amine Primer, Epoxy Side | — |
| TI-PURE R-960 Titanium Dioxide | The Chemours Company |
| (PW6) | (Wilmington, DE) |
| MONASTRAL Green 6Y-C (PG7) | Heubach GmbH |
| | (Langelsheim, Germany) |
| SNOW WHITE Filler (CaSO₄) | USG Corporation |
| | (Chicago, IL) |
| Fluorescent Pigment DAYGLO T-17 | Day-Glo Color Corp. |
| Saturn Yellow | (Cleveland, OH) |
| ENDURE Fluorescent Yellow EFL-17 | Day-Glo Color Corp. |
| | (Cleveland, OH) |
| Green Phosphor (SrAl2O4: Eu, Dy) | Sigma Aldrich |
| | (St. Louis, MO) |
| 2K Epoxy/Amine Primer, Amine Side | — |
| TURCO 6849 Aqueous Alkaline Degreaser | Henkel AG & Co. |
| | (Düsseldorf, Germany) |

The cleaner solution used herein was prepared from the following materials from Table 2.

TABLE 2

| Material | Volume (mL) |
|---|---|
| TURCO 6849 | 2160 |
| Tap water | 8640 |

For all examples, units of volume are milliliters and units of mass are grams.

UV fluorescent primer or interlayer coating compositions for Examples 1-4 were prepared by modifying existing products as shown in Table 3.

TABLE 3

| | | Base | Fluorescent | Activator | Thinner |
|---|---|---|---|---|---|
| Example | Layer | Component | Pigment | Component | Component |
| Example 1 | Primer | DESOPRIME | T17 Saturn | DESOPRIME | N/A |
| | | CA7700 | Yellow | CA7700B | |
| Example 2 | Primer | DESOPRIME | T17 Saturn | DESOPRIME | DESOPRIME |
| | | CA7502E | Yellow | CA7502EB | CA7502EC |
| Example 3 | Primer | DESOTHANE | T17 Saturn | DESOTHANE | DESOTHANE |
| | | CA8000/S115 | Yellow | CA8000B | CA8000C |
| Example 4 | Primer | DESOPRIME | N/A | DESOPRIME | DESOPRIME |
| | | CA7502E | | CA7502EB | CA7502EC |
| Example 4 | Interlayer | DESOTHANE | T17 Saturn | DESOTHANE | DESOTHANE |
| | | CA8000/S115 | Yellow | CA8000B | CA8000C |

Lab-created UV fluorescent primer or interlayer coating compositions for Examples 5-10 were prepared as shown in Table 4.

TABLE 4

| | Base | Conventional | Fluorescent or |
|---|---|---|---|
| Example | Component | Pigments | Phosphorescent Pigment |
| Example 5 | 2K Epoxy/Amine | PG7, PW6, | DAYGLO T17 Saturn |
| | Primer, Epoxy | CaSO₄ | Yellow |
| | Side | Filler | |
| Example 6 | 2K Epoxy/Amine | PG7, PW6, | Green Phosphor; |
| | Primer, Epoxy | CaSO₄ | (SrAl₂O₄: |
| | Side | Filler | Eu, Dy) |
| Example 7 | 2K Epoxy/Amine | CaSO₄ Filler | ENDURE EFL-17 |
| | Primer, Epoxy | | Yellow |
| | Side | | |
| Example 8 | 2K Epoxy/Amine | CaSO₄ Filler | DAYGLO T17 Saturn |
| | Primer, Epoxy | | Yellow |
| | Side | | |
| Example 9 | 2K Epoxy/Amine | CaSO₄ Filler | ENDURE EFL-17 |
| | Primer, Epoxy | | Yellow |
| | Side | | |
| Example | 2K Epoxy/Amine | CaSO₄ Filler | DAYGLO T17 Saturn |
| 10 | Primer, Epoxy | | Yellow |
| | Side | | |

For Examples 1-10 the following topcoat formulations were used as shown in Table 5.

TABLE 5

| | | Topcoat |
|---|---|---|
| Example | Topcoat Base | Activator |
| Example 1 | DESOTHANE CA9311/F36170 | DESOTHANE |
| | Gray | CA9311B |
| Example 2 | DESOTHANE CA9311/F36170 | DESOTHANE |
| | Gray | CA9311B |
| Example 3 | DESOTHANE CA9311/F36170 | DESOTHANE |
| | Gray | CA9311B |
| Example 4 | DESOTHANE CA9311/F36170 | DESOTHANE |
| | Gray | CA9311B |
| Example 5 | DESOTHANE CA 9007 | DESOTHANE |
| | BAC70846 White | CA9007B |
| Example 6 | DESOTHANE CA 9007 | DESOTHANE |
| | BAC70846 White | CA9007B |
| Example 7 | DESOTHANE CA9311/F37078 | DESOTHANE |
| | Black | CA9311B |
| Example 8 | DESOTHANE CA9311/F37078 | DESOTHANE |
| | Black | CA9311B |
| Example 9 | DESOTHANE CA9311/F36170 | DESOTHANE |
| | Gray | CA9311B |
| Example | DESOTHANE CA9311/F36170 | DESOTHANE |
| 10 | Gray | CA9311B |

### Examples 1-3

The primer coating compositions of Examples 1-3 were prepared by adding 95 weight percent of commercial primer product or base component into a clean container, then adding 5 weight percent of fluorescent pigment. The two components were blended with a Cowles blade at medium speed for 10 minutes. After full incorporation of the fluorescent pigment, the paint was activated by adding the amounts of the corresponding activator and corresponding thinner (if applicable from Table 1) at the volume ratios specified by the manufacture's technical data sheet. If an induction period was required for the commercial product, it was allowed to rest for the specified interval at room temperature.

The coatings of were spray applied onto chromate-pretreated 2024T0 aluminum alloy substrate panels with an air atomized spray gun. After application of the primer layer, it was allowed to cure for 2 hours, and a topcoat, as specified in Table 5, that comprises a pigment that blocks radiation corresponding to the excitation and/or emission wavelength of the fluorescent and/or phosphorescent pigment in the primer coating layer was applied using an air-atomized spray gun. The topcoat components were mixed at the volume ratios specified by the manufacture's technical data sheet and spray applied. After fully curing, the coatings were cut using a razor blade in a hash mark pattern, and were impacted using a GARDCO impact tester to generate cracks in the topcoat.

Scratches or dents exposing fluorescent primer were visualized using either UVA light in a light booth or a portable UV flashlight (365 nm). Pictures were taken using a high-quality digital camera for further review. Images were further analyzed by using ImageJ (an image processing software). After splitting the full color image into Red, Green, and Blue channels, the Green channel corresponded with the location of any defects visualized by UV light.

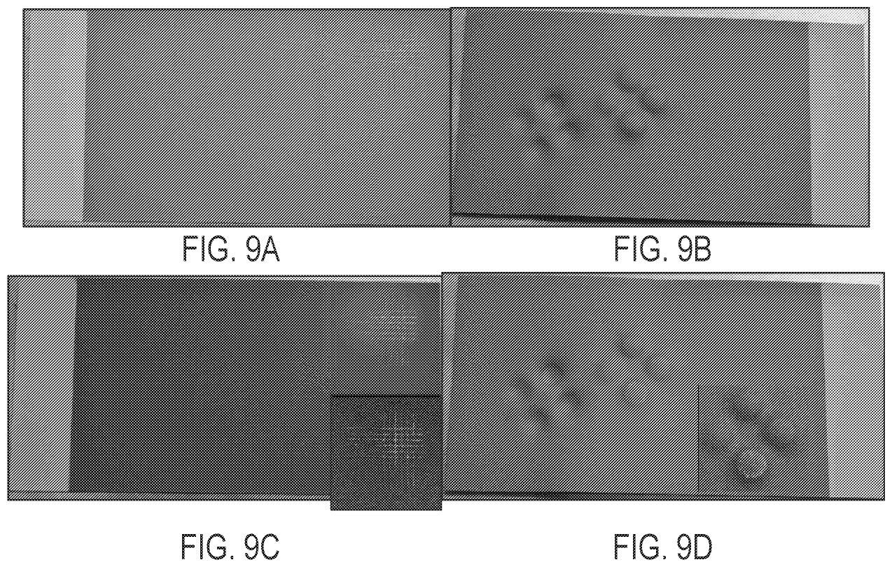

FIGS. 9A and 9B show pictures of Example 1 taken using a high-quality digital camera under ambient lab lighting. FIGS. 9C and 9D show pictures of Example 1 taken using a high-quality digital camera under ambient lab lighting and further illuminated by the UV flashlight. The miniatures appended to FIGS. 9C and 9D show the images further analyzed by using ImageJ corresponding to the Green channel. As is evident from FIGS. 9A-9D, the damaged regions became more apparent under UV lighting based on the exposed primer layer fluorescing at the emission wavelength.

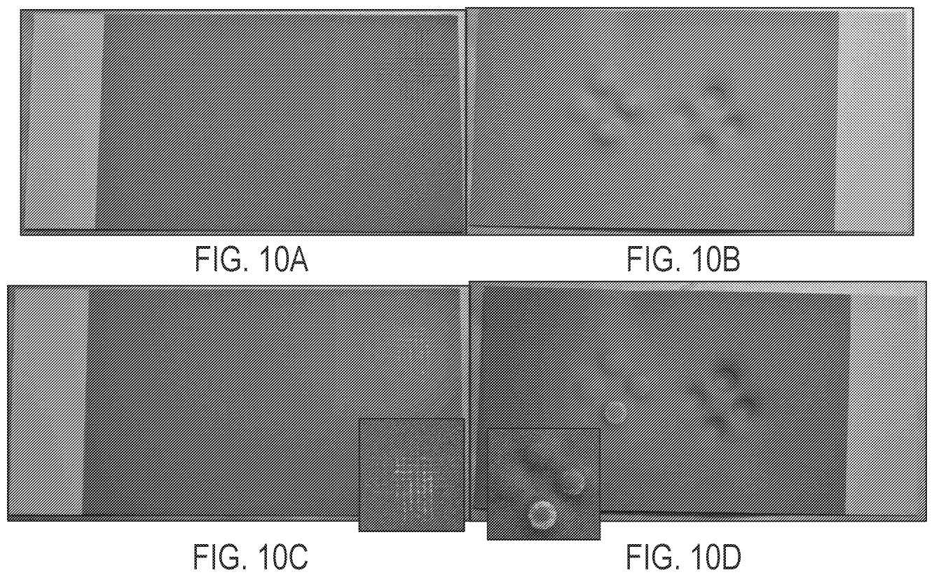

FIGS. 10A and 10B show pictures of Example 2 taken using a high-quality digital camera under ambient lab lighting. FIGS. 10C and 10D show pictures of Example 2 taken using a high-quality digital camera under ambient lab lighting and further illuminated by the UV flashlight. The miniatures appended to FIGS. 10C and 10D show the images further analyzed by using ImageJ corresponding to the Green channel. As is evident from FIGS. 10A-10D, the damaged regions became more apparent under UV lighting based on the exposed primer layer fluorescing at the emission wavelength.

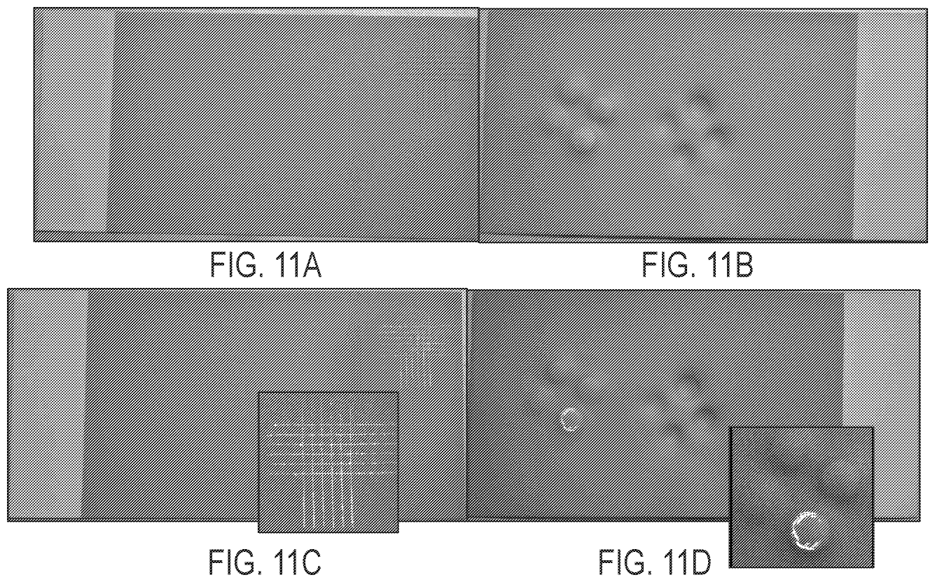

FIGS. 11A and 11B show pictures of Example 3 taken using a high-quality digital camera under ambient lab lighting. FIGS. 11C and 11D show pictures of Example 3 taken using a high-quality digital camera under ambient lab lighting and further illuminated by the UV flashlight. The miniatures appended to FIGS. 11C and 11D show the images further analyzed by using ImageJ corresponding to the Green channel. As is evident from FIGS. 11A-11D, the damaged regions became more apparent under UV lighting based on the exposed primer layer fluorescing at the emission wavelength.

### Example 4

The primer coating composition of Example 4 was mixed according to the technical instructions. It was then applied to chromate-pretreated 2024T0 aluminum alloy substrate panels with an air-atomized spray gun and was allowed to fully cure. The fluorescent interlayer composition was prepared identically to the primer layer of Example 3, by adding 5 weight percent of fluorescent pigment to 95 weight percent clear polyol base component CA8000/S115 Clear and mixing with a Cowles blade at medium speed for 10 minutes. This component was mixed with activator and thinner as specified in the technical instructions and was applied with an air-atomized spray gun. After full curing of this interlayer, a gray topcoat layer that comprises a pigment that blocks radiation corresponding to the excitation and/or emission wavelength of the fluorescent and/or phosphorescent pigment in the interlayer coating layer was applied using an air atomized spray gun. The topcoat components were mixed as specified in the product documentation. After fully curing, the coatings were cut using a razor blade in a hash mark pattern, and were impacted using a GARDCO impact tester to generate cracks in the topcoat.

Scratches or dents exposing fluorescent primer were visualized using either UVA light in a light booth or a portable UV flashlight (365 nm). Pictures were taken using a high-quality digital camera for further review. Images were further analyzed by using ImageJ (an image processing software). After splitting the full color image into Red, Green, and Blue channels, the Green channel corresponded with the location of any defects visualized by UV light.

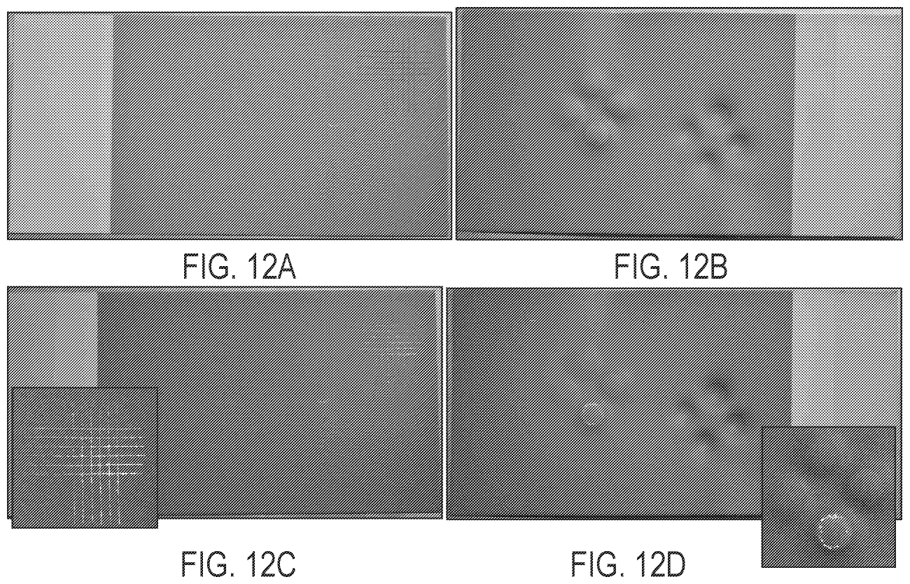

FIGS. 12A and 12B show pictures of Example 4 taken using a high-quality digital camera under ambient lab lighting. FIGS. 12C and 12D show pictures of Example 4 taken using a high-quality digital camera under ambient lab lighting and further illuminated by a UV flashlight. The miniatures appended to FIGS. 12C and 12D show the images further analyzed by using ImageJ corresponding to the Green channel. As is evident from FIGS. 12A-12D, the damaged regions became more apparent under UV lighting based on the exposed interlayer fluorescing at the emission wavelength.

### Examples 5 and 6

The primer coating compositions of Example 5 and Example 6 were formulated by preparing a two-component epoxy-amine primer in a manner common to an experienced formulator. The epoxy side of the formulation includes the pigments listed in Table 4, including the two tinting pigments Titanium Dioxide (PW6) and Phthalo Green (PG7). The epoxy side, after addition of the pigments, was milled to a Hegman grind of six. In Example 5, the fluorescent pigment was added at 5 weight percent to 95 weight percent of the prepared epoxy side. In Example 6, the phosphorescent pigment was added at 10 weight percent to 90 weight percent of the prepared epoxy side. In either case, the mixtures were blended with a Cowles blade at medium-high speed for 10 minutes. The amine side was prepared in a manner common to an experienced formulator. The two components were blended at a ratio sufficient to achieve an epoxy:amine equivalent weight range of 0.8:1 to 1:1, and the activated coating composition was allowed a 30 to 45 minute induction time. These coating compositions were applied over a Leneta card in parallel with a drawdown bar to a wet film thickness of 2.0 mil (51 μm). After drying for one hour, masking tape was applied to the top of the coated paper. After full cure, CA 9007 BAC70846 white base component that comprises a pigment that blocks radiation corresponding to the excitation and/or emission wavelength of the fluorescent and/or phosphorescent pigment in the primer coating layer was mixed with CA 9007B Activator at a 2:1 weight ratio. This coating was applied via drawdown bar over the primers at a wet film thickness of 4.0 mil (102 μm). After the topcoat was fully cured, a razor blade was used to cut through the top layer.

Scratches exposing fluorescent primer were visualized using UVA light in a light booth. Pictures were taken using a high-quality digital camera for further review. Images were further analyzed by using ImageJ (an image processing software). After splitting the full color image into Red, Green, and Blue channels, the Green channel corresponded with the location of any defects visualized by UV light.

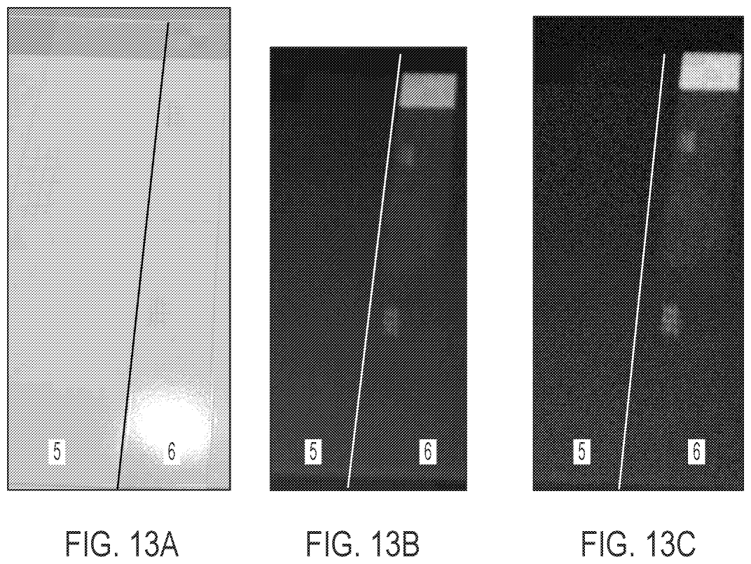

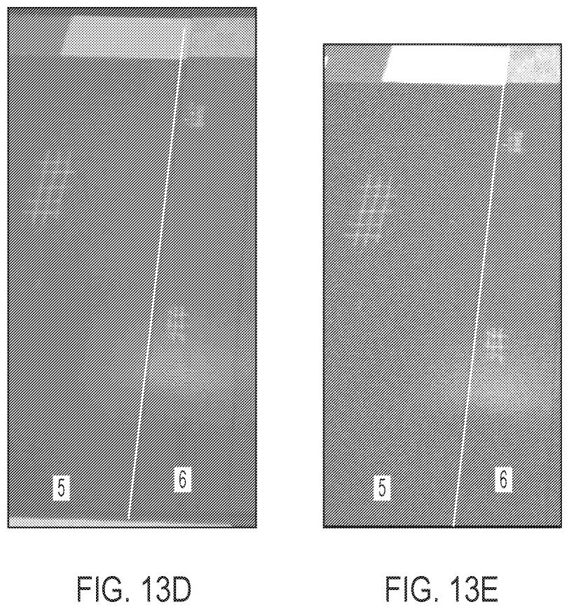

The left portion of FIG. 13A shows a picture of Example 5 taken using a high-quality digital camera under ambient lab lighting. The left portion of FIG. 13B shows a picture of Example 5 taken using a high-quality digital camera in dark conditions (damage not visible due to pigment being fluorescent pigment which ceases fluorescing nearly immediately after radiation source removed); the left portion of FIG. 13C shows FIG. 13B further analyzed by using ImageJ corresponding to the Green channel. The left portion of FIG. 13D shows a picture of Example 5 taken using a high-quality digital camera in ambient lab lighting conditions and exposed to the UVA light; the left portion of FIG. 13E shows FIG. 13D further analyzed by using ImageJ corresponding to the Green channel. As is evident from the left portions of FIGS. 13A-13E, the damaged regions became more apparent under UV lighting based on the exposed primer layer fluorescing at the emission wavelength.

The right portion of FIG. 13A shows a picture of Example 6 taken using a high-quality digital camera under ambient lab lighting. The right portion of FIG. 13B shows a picture of Example 6 taken using a high-quality digital camera in dark conditions (damage visible due to pigment being phosphorescent pigment which fluoresces for a period of time after the radiation source is removed); the right portion of FIG. 13C shows FIG. 13B further analyzed by using ImageJ corresponding to the Green channel. The right portion of FIG. 13D shows a picture of Example 6 taken using a high-quality digital camera in ambient lab lighting conditions and exposed to the UVA light; the right portion of FIG. 13E shows FIG. 13D further analyzed by using ImageJ corresponding to the Green channel. As is evident from the right portions of FIGS. 13A-13E, the damaged regions became more apparent under UV lighting based on the exposed primer layer phosphorescing at the emission wavelength.

### Examples 7-10

The primer coating compositions of Examples 7-10 were formulated by preparing a two-component epoxy-amine primer in a manner common to an experienced formulator. The epoxy side of the formulation includes filler pigment listed in Table 4, excluding the two tinting pigments (see Examples 5 and 6). The epoxy side, after addition of the filler, was milled to a Hegman grind of six. The fluorescent pigments were added at 5 weight percent to 95 weight percent of the prepared epoxy side. The mixture was blended with a Cowles blade at medium-high speed for 10 minutes. The amine side was prepared in a manner common to an experienced formulator. The two components were blended at a ratio sufficient to activate the coating, and the activated coating was allowed a 30 to 45 minute induction time.

The coating compositions were spray applied onto 2024T3 (Examples 7-10) and chromate-pretreated 2024T0 (Examples 7 and 8 only) aluminum alloy substrate panels with an air atomized spray gun. Prior to coating application, the aluminum 2024T3 bare substrate (Bralco Metals, Wichita KS) measuring 12″×12″×0.032″ was hand-wiped with methyl ethyl ketone (100%) and a disposable cloth and allowed to air dry prior to chemical cleaning. The panel was sprayed with the cleaner solution and abraded using a circular sander and Scotch Brite. The panel was then washed with tap water twice and dried using a clean cloth, then allowed to fully air dry before coating application.

After application of the primer coating composition, it was allowed to cure for 2 hours, and either a black (Examples 7 and 8) or gray (Examples 9 and 10) topcoat composition that comprises a pigment that blocks radiation corresponding to the excitation and/or emission wavelength of the fluorescent and/or phosphorescent pigment in the primer coating layer was applied using an air atomized spray gun. In either case, the paint components were mixed according to the technical instructions. After fully curing, the coatings painted onto T3 panels were cut using a razor blade in a hash mark pattern, and the TO panels were impacted using a GARDCO impact tester to generate cracks in the topcoat.

Scratches or dents exposing fluorescent primer were visualized using either UVA light in a light booth or a portable UV flashlight (365 nm). Pictures were taken using a high-quality digital camera for further review. Images were further analyzed by using ImageJ (an image processing software). After splitting the full color image into Red, Green, and Blue channels, the Green channel corresponded with the location of any defects visualized by UV light.

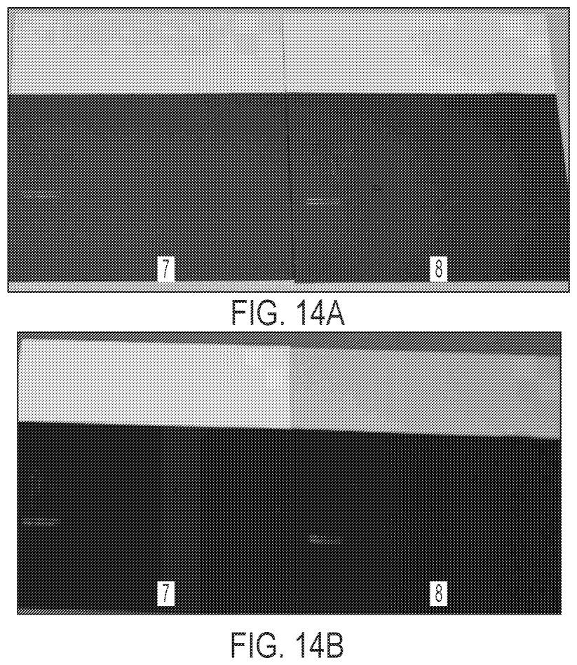

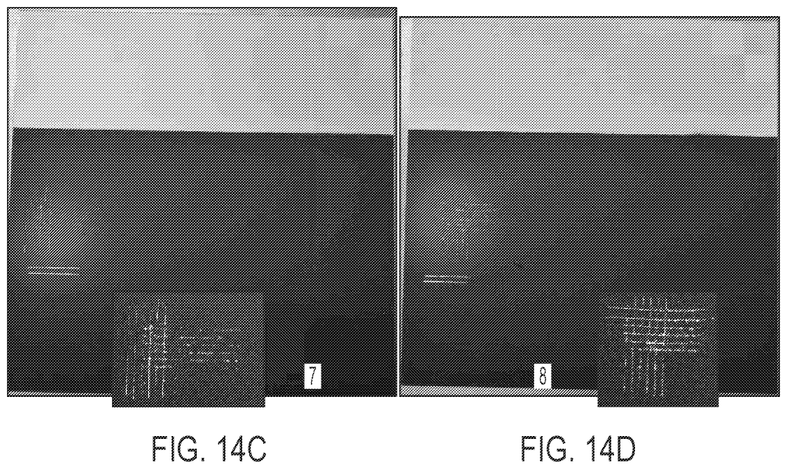

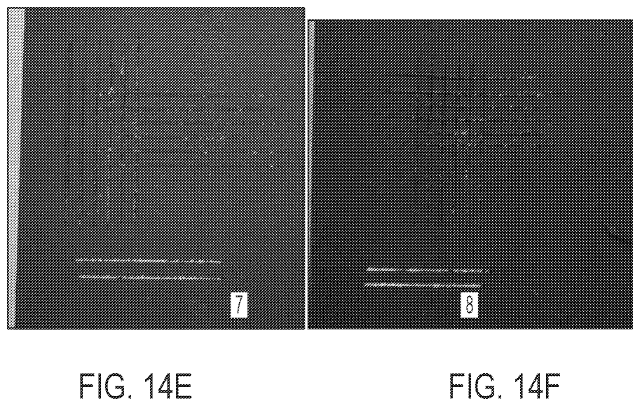

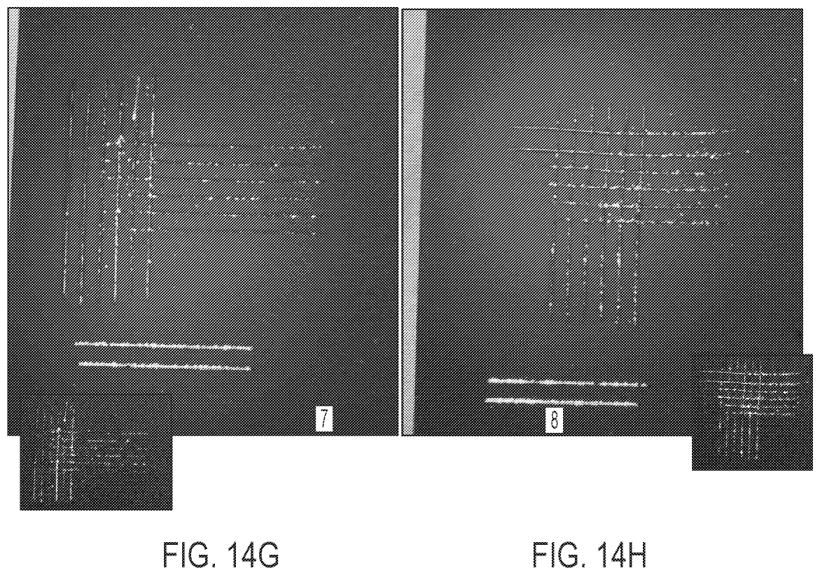

The left portion of FIG. 14A shows a picture of Example 7 taken using a high-quality digital camera under ambient lab lighting. The left portion of FIG. 14B shows a picture of Example 7 taken using a high-quality digital camera and exposed to the UVA light booth. The left portion of FIG. 14C shows a picture of Example 7 taken using a high-quality digital camera and exposed to the 365 nm UV flashlight, with a miniature appended thereto showing the image further analyzed by using ImageJ corresponding to the Green channel. The left portion of FIG. 14D shows a zoomed-in view of FIG. 14A. The left portion of FIG. 14E shows a zoomed-in view of FIG. 14C, with a miniature appended thereto showing the image further analyzed by using ImageJ corresponding to the Green channel. As is evident from the left portions of FIGS. 14A-14E, the damaged regions became more apparent under UV lighting based on the exposed primer layer fluorescing at the emission wavelength.

The right portion of FIG. 14A shows a picture of Example 8 taken using a high-quality digital camera under ambient lab lighting. The right portion of FIG. 14B shows a picture of Example 8 taken using a high-quality digital camera and exposed to the UVA light booth. The right portion of FIG. 14C shows a picture of Example 8 taken using a high-quality digital camera and exposed to the 365 nm UV flashlight, with a miniature appended thereto showing the image further analyzed by using ImageJ corresponding to the Green channel. The right portion of FIG. 14D shows a zoomed-in view of FIG. 14A. The right portion of FIG. 14E shows a zoomed-in view of FIG. 14C, with a miniature appended thereto showing the image further analyzed by using ImageJ corresponding to the Green channel. As is evident from the right portions of FIGS. 14A-14E, the damaged regions became more apparent under UV lighting based on the exposed primer layer fluorescing at the emission wavelength.

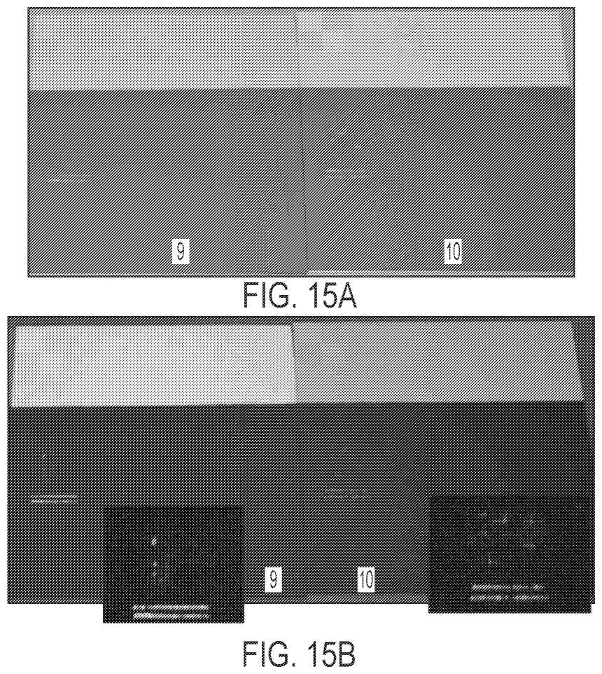

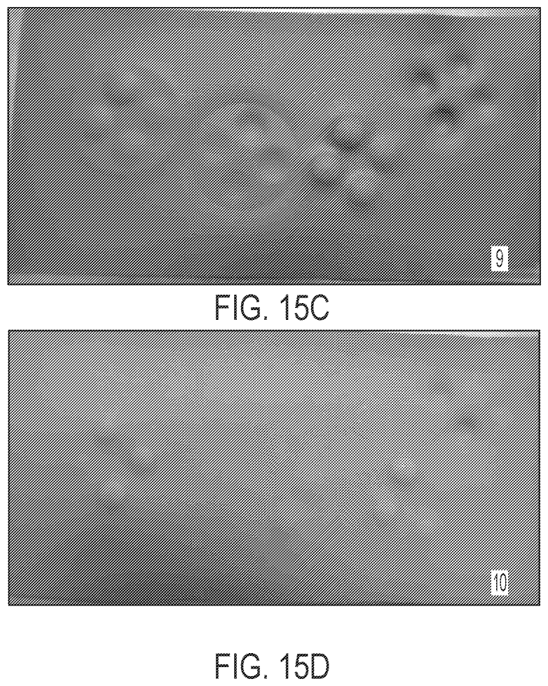

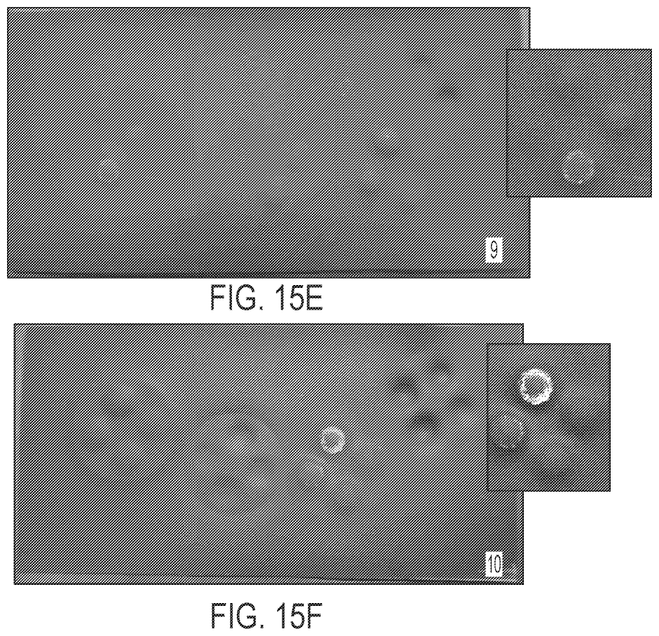

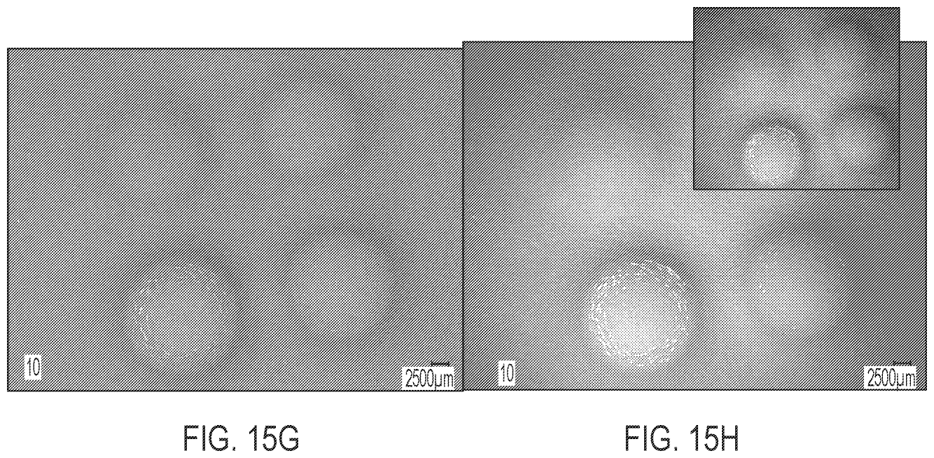

The left portion of FIG. 15A shows a picture of scratched Example 9 taken using a high-quality digital camera under ambient lab lighting. The left portion of FIG. 15B shows a picture of scratched Example 9 taken using a high-quality digital camera and exposed to the UVA light booth, with a miniature appended thereto showing the image further analyzed by using ImageJ corresponding to the Green channel. FIG. 15C shows a picture of dented Example 9 taken using a high-quality digital camera under ambient lab lighting. FIG. 15E shows a picture of dented Example 9 taken using a high-quality digital camera and exposed to the 365 nm UV flashlight, with a miniature appended thereto showing the image further analyzed by using ImageJ corresponding to the Green channel. As is evident from FIGS. 15A-15C and 15E, the damaged regions became more apparent under UV lighting based on the exposed primer layer fluorescing at the emission wavelength.

The right portion of FIG. 15A shows a picture of scratched Example 10 taken using a high-quality digital camera under ambient lab lighting. The right portion of FIG. 15B shows a picture of scratched Example 10 taken using a high-quality digital camera and exposed to the UVA light booth, with a miniature appended thereto showing the image further analyzed by using ImageJ corresponding to the Green channel. FIG. 15D shows a picture of dented Example 10 taken using a high-quality digital camera under ambient lab lighting. FIG. 15F shows a picture of dented Example 10 taken using a high-quality digital camera and exposed to the 365 nm UV flashlight, with a miniature appended thereto showing the image further analyzed by using ImageJ corresponding to the Green channel. FIG. 15G shows a picture of dented Example 10 taken using a high-quality digital camera at 10× magnification from a digital microscope under ambient lab lighting. FIG. 15H shows a picture of dented Example 10 taken using a high-quality digital camera at 10× magnification from a digital microscope and exposed to the 365 nm UV flashlight, with a miniature appended thereto showing the image further analyzed by using ImageJ corresponding to the Green channel. As is evident from FIGS. 15A, 15B, 15D, 15F, 15G, and 15H, the damaged regions became more apparent under UV lighting based on the exposed primer layer fluorescing at the emission wavelength.

### Examples 11-12

### IR Fluorescent or Phosphorescent Primers/Interlayers

The following materials from Table 6 were used in Examples 11-12.

TABLE 6

| Component | Supplier |
|---|---|
| BONDERITE C-IC SMUTGO NC AERO | Henkel AG & Co. |
| (known as TURCO Liquid SMUTGO NC) | (Düsseldorf, Germany) |
| 2K Epoxy/Amine Primer, Epoxy Side | — |
| 2K Epoxy/Amine Primer, Amine | — |
| Side, no pigment | |
| Fluorescing pigment EX1635 | Shepherd Color Company |
| | (Cincinnati, OH) |

The deoxidizer solution used herein was prepared from the following materials from Table 7.

TABLE 7

| Material | Volume (mL) |
|---|---|
| BONDERITE C-IC | 2160 |
| SMUTGO NC AERO | |
| Deionized water | 8640 |

A fluorescing pigment dispersion was prepared according to Table 8 below by weighing the pigment and 25.0 grams of xylene into a glass jar along with 30 grams of dispersing media. The jars were sealed with lids and then placed on a Lau DAS 200 Dispersing Unit (Lau GmbH) with a dispersion time of 2 hours. Finally, the remainder of xylene was added to the pigment/solvent dispersion.

TABLE 8

| Material | Mass (g) |
|---|---|
| EX1635 pigment | 15.0 |
| xylene | 40.0 |

Primer coating compositions of Examples 11 and 12 were prepared according to Table 9 below.

TABLE 9

| | | | Fluorescing |
|---|---|---|---|
| | Epoxy | Amine Side, | Pigment |
| Example | Side | non-pigmented | Dispersion |
| Comparative Example 11 | Yes | Yes | No |
| Example 12 | Yes | Yes | Yes |

### Comparative Example 11

The primer coating composition of Comparative Example 11 was formulated by preparing a two-component epoxy-amine primer in a manner common to an experienced formulator using the epoxy side and the non-pigmented (without tinting pigment) amine side, both listed in Table 9. The two components were blended at a ratio sufficient to activate the coating.

### Example 12

The primer coating composition of Example 12 was formulated by preparing a two-component epoxy-amine primer in a manner common to an experienced formulator using the epoxy side and the non-pigmented (without tinting pigment) amine side. Next the fluorescing pigment dispersion was added to the mixture of Example 12 at a weight percentage of 4.5% while stirring by hand.

For Examples 11 and 12, the primer coating compositions were given an induction time of 30-45 minutes prior to application. The coatings of were spray applied onto 2024T3 aluminum alloy substrate panels using an air atomized spray gun. Prior to coating application, the aluminum 2024T3 bare substrate (Bralco Metals, Wichita KS) measuring 3″×5″×0.032″ was hand-wiped with methyl ethyl ketone (100%) and a disposable cloth and allowed to air dry prior to chemical cleaning. The panel was immersed in the cleaner solution for 5 minutes at 130° F. (54° C.) with mild agitation. The panel was then immersed in a tap water rinse for 2.5 minutes at 110° F. (43° C.) with mild agitation followed by a second tap water immersion rinse for 2.5 minutes at 110° F. (43° C.) with mild agitation. The panel was then rinsed with a gentle deionized water spray for 5 seconds. The panel was immersed in the deoxidizer solution for 5 minutes at ambient temperature followed by a tap water immersion rinse for 1 minute at ambient temperature with mild agitation followed by a second immersion in tap water rinse for 1 minute at ambient temperature with mild agitation. The panel was then rinsed with a gentle deionized water spray for 5 seconds. The panels were left to dry at ambient conditions before coating application.

The primer-coated panels were then partially masked using aluminum foil and masking tape. A commercially available topcoat composition (Topcoat Base DESOTHANE CA9311/F36173 and Topcoat Activator DESOTHANE CA9311B, both from PPG Industries, Inc. (Pittsburgh, PA), mixed at the volume ratios specified by the product documentation) that comprises a pigment that blocks radiation corresponding to the excitation and/or emission wavelength of the fluorescent and/or phosphorescent pigment in the primer coating layer was applied using an air atomizing spray gun over the partially masked primer-coated panels and cured at ambient temperature conditions for 14 days. Then, the mask was removed such that a section of the primer layer was exposed, simulating damage to the topcoat layer.

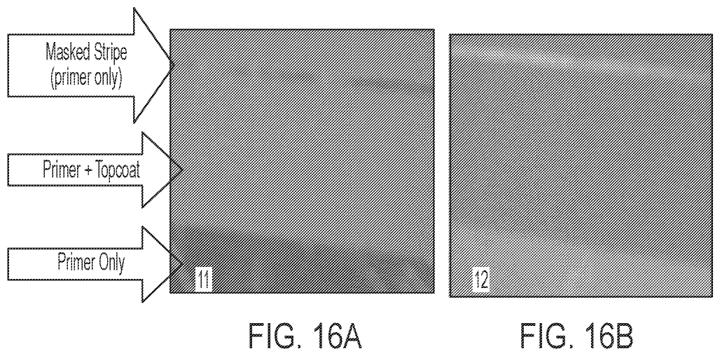

FIG. 16A shows a picture taken using a digital camera of the panel coated according to Comparative Example 11 and exposed to near-infrared radiation having a wavelength of 850 nm. FIG. 16B shows a picture taken using a digital camera of the panel coated according to Example 12 and exposed to near-infrared radiation having a wavelength of 850 nm. As can be seen from FIGS. 16A and 16B, the previously masked section in which the primer was exposed is more visible under infrared radiation in FIG. 16B in which the primer composition was formulated to include an infrared fluorescent and/or phosphorescent pigment.

Whereas particular embodiments of this disclosure have been described above for purposes of illustration, it will be evident to those skilled in the art that numerous variations of the details of the present disclosure may be made without departing from the disclosure as defined in the appended claims.

1. A multi-layer coating system, comprising:
a first coating layer formed from a first coating composition comprising:
a film forming resin; and
a fluorescent and/or phosphorescent pigment, wherein the fluorescent and/or phosphorescent pigment:
(1) emits radiation at an emission wavelength in the range of from 400 to 1200 nanometers when excited by ultraviolet and/or visible radiation corresponding to an excitation wavelength of the fluorescent and/or phosphorescent pigment; and/or
(2) emits radiation at an emission wavelength in the range of from 600 to 2500 nanometers when excited by visible and/or near infrared radiation corresponding to an excitation wavelength of the fluorescent and/or phosphorescent pigment; and
a second coating layer disposed over at least a portion of the first coating layer, wherein the second coating layer is formed from a second coating composition comprising:
a film forming resin; and
a pigment that blocks radiation corresponding to the excitation and/or emission wavelength of the fluorescent and/or phosphorescent pigment in the first coating layer.

2. (canceled)

3. (canceled)

4. The multi-layer coating system of any of claims 14e-3, wherein the second coating layer blocks an effective percent of radiation incident to the second coating layer and corresponding to the emission wavelength of the fluorescent and/or phosphorescent pigment in the first coating layer, such that any of the incident radiation corresponding to the emission wavelength of the fluorescent and/or phosphorescent pigment in the first coating layer transmitted through the second coating layer is below a sensitivity threshold of a radiation detector.

5. The multi-layer coating system of claim 1, wherein the second coating layer is in direct contact with at least a portion of the first coating layer.

6. The multi-layer coating system of claim 1, further comprising an intermediate layer positioned between at least a portion of the second coating layer and the first coating layer.

7. (canceled)

8. The multi-layer coating system of claim 1, wherein the emission wavelength comprises a wavelength detectable by an infrared camera and/or an ultraviolet-visible-infrared spectrophotometer.

9. The multi-layer coating system of claim 1, wherein the second coating layer forms a topcoat layer.

10. The multi-layer coating system of claim 1, wherein the pigment in the second coating composition that blocks radiation absorbs and/or reflects the radiation corresponding to the excitation and/or emission wavelength of the fluorescent and/or phosphorescent pigment in the first coating layer.

11. The multi-layer coating system of claim 1, wherein the film forming resin of the first coating composition comprises an epoxy amine resin and/or a polyurethane resin.

12. The multi-layer coating system of claim 1, wherein the first coating composition further comprises a corrosion inhibitor.

13. The multi-layer coating system of claim 1, wherein the first coating composition is substantially free of a tinting pigment.

14. A substrate at least partially coated with the multi-layer coating system of claim 1.

15. (canceled)

16. (canceled)

17. The substrate of claim 14, wherein the substrate comprises an aircraft.

18. The substrate of claim 14, wherein the substrate comprises aluminum, a carbon fiber reinforced material, a composite material, and/or a combination thereof.

19. (canceled)

20. A method for detecting a damaged region of a multi-layer coating system applied to a substrate, comprising:
detecting radiation emitted from a first coating layer formed from a first coating composition comprising:
a film forming resin; and
a fluorescent and/or phosphorescent pigment, wherein the fluorescent and/or phosphorescent pigment:
(1) emits radiation at an emission wavelength in the range of from 400 to 1200 nanometers when excited by ultraviolet and/or visible radiation corresponding to an excitation wavelength of the fluorescent and/or phosphorescent pigment; and/or
(2) emits radiation at an emission wavelength in the range of from 600 to 2500 nanometers when excited by visible and/or near infrared radiation corresponding to an excitation wavelength of the fluorescent and/or phosphorescent pigment; and
a second coating layer disposed over at least a portion of the first coating layer, wherein the second coating layer is formed from a second coating composition comprising:
a film forming resin; and
a pigment that blocks radiation corresponding to the excitation and/or emission wavelength of the fluorescent and/or phosphorescent pigment in the first coating layer; wherein the detection of radiation from the first coating layer indicates damage to at least the second coating layer.

21. The method of claim 20, wherein the radiation emitted from a first coating layer is detected by a naked human eye, an infrared camera, and/or an ultraviolet-visible-infrared spectrophotometer.

22. The method of claim 20, further comprising:
directing radiation from a radiation source at the multi-layer coating system, wherein the radiation source directs the radiation at the excitation wavelength of the fluorescent and/or phosphorescent pigment, wherein the radiation source comprises a flashlight emitting ultraviolet radiation, visible radiation, and/or infrared radiation.

23. (canceled)

24. (canceled)

25. (canceled)

26. (canceled)

27. (canceled)

28. (canceled)

29. A vehicle at least partially coated with the multi-layer coating system of claim 1.

30. An aircraft at least partially coated with the multi-layer coating system of claim 1.

31. (canceled)

32. Use of the multi-layer coating system of claim 1 to detect a damaged region of a coated substrate.

33. (canceled)

34. A kit for forming a multi-layer coating system, comprising:
a first container comprising a first coating composition comprising:
a film forming resin; and
a fluorescent and/or phosphorescent pigment, wherein the fluorescent and/or phosphorescent pigment:
(1) emits radiation at an emission wavelength in the range of from 400 to 1200 nanometers when excited by ultraviolet and/or visible radiation corresponding to an excitation wavelength of the fluorescent and/or phosphorescent pigment; and/or
(2) emits radiation at an emission wavelength in the range of from 600 to 2500 nanometers when excited by visible and/or near infrared radiation corresponding to an excitation wavelength of the fluorescent and/or phosphorescent pigment; and
a second container comprising a second coating composition comprising:
a film forming resin; and
a pigment that blocks radiation corresponding to the excitation and/or emission wavelength of the fluorescent and/or phosphorescent pigment in the first coating layer.
